(19) United States
(12) Patent Application Publication
(10) Pub. No.: US 2026/0027548 A1
(43) Pub. Date: Jan. 29, 2026

(54) Super Absorbent Polymer

(71) Applicant: LG Chem, Ltd., Seoul (KR)

(72) Inventors: Kanguk Kim, Seoul (KR); Sung Soo Park, Seoul (KR); Kwangin Shin, Seoul (KR); Junwye Lee, Seoul (KR); Eunbyeol Ko, Seoul (KR); Kyung Inn Kim, Seoul (KR); Minhwa Shin, Seoul (KR)

(73) Assignee: LG Chem, Ltd., Seoul (KR)

(21) Appl. No.: 19/258,113

(22) Filed: Jul. 2, 2025

(30) Foreign Application Priority Data
Jul. 29, 2024 (KR) 10-2024-0100100

(51) Int. Cl. B01J 20/26; B01J 20/02; B01J 20/10; B01J 20/28; B01J 20/30

(52) U.S. Cl. CPC B01J 20/267; B01J 20/0281; B01J 20/103; B01J 20/261; B01J 20/28004; B01J 20/28047; B01J 20/28057; B01J 20/3021; B01J 20/3085; C08F 20/06; C08K 3/11; C08L 33/02; B01J 2220/68

(57) ABSTRACT

A super absorbent polymer of a polyacrylic acid (salt)-based super absorbent polymer, has a surface area of 45 mm⁻¹ or more relative to an actual volume, and a deodorization rate of 40% or more according to the following Equation 1 for dimethyl disulfide (DMDS) or dimethyl trisulfide (DMTS): [Equation 1] Deodorization rate (%)=(1−Cs/Co)×100. In Equation 1, Cs is a peak area of an odor standard substance in a gas chromatography-mass spectrometry (GC-MS) graph for an odor standard substance solution that contacted the super absorbent polymer at 35° C. for 2 hours, and Co is a peak area of an odor standard substance in a gas chromatography-mass spectrometry graph for an odor standard substance solution that contacted a control group at 35° C. for 2 hours.

### CROSS-REFERENCE TO RELATED APPLICATION

This application claims priority to Korean Patent Application No. 10-2024-0100100 filed on Jul. 29, 2024, the content of which is incorporated by reference in its entirety.

### BACKGROUND

The present disclosure relates to a super absorbent polymer having both excellent absorption performance and deodorizing effects against odor-causing substances.

Super absorbent polymers (SAP) are synthetic polymer materials that may absorb 500 to 1,000 times its own weight in water, and each developer has a different name such as SAM (Super Absorbency Material) or AGM (Absorbent Gel Material). The above-mentioned super absorbent polymers began to be put to practical use in diapers, sanitary products, etc., and are currently widely used as a soil conditioner for gardening, a water-retaining material for civil engineering and construction, a sheet for raising seedings, a freshness-preserving agent in the food distribution industry, and a steaming agent.

In particular, super absorbent polymers are mainly used in sanitary products such as diapers and sanitary pads, so it is necessary to have not only high absorption performance but also a fast absorption rate.

In addition, in order to provide products with a thinner thickness, the development of so-called pulpless products, in which the pulp content is reduced or even no pulp is used at all, is actively conducted. As a result, the product contains a relatively high proportion of super absorbent polymers, and super absorbent polymer particles are inevitably included in multiple layers in the product. Accordingly, the importance of the absorption rate of the super absorbent polymer is increasing.

For this, a method of forming a porous structure in a base resin powder by including a foaming agent in a monomer composition and performing crosslinking polymerization to expand the surface area of the super absorbent polymer is generally used.

However, the use of the foaming agent has caused problems in that various physical properties of the super absorbent polymer, such as surface tension, liquid permeability, and bulk density, are deteriorated.

In addition, the environment in which the super absorbent polymers are used is one in which microorganisms harmful to the human body and causing odors, such as bacteria and mold, may easily proliferate, and thus, unpleasant odors may be generated by the microorganisms during use, and therefore, the deodorizing effects are additionally required for the super absorbent polymers.

However, if the structure or physical properties of the super absorbent polymers are adjusted for deodorizing function, the absorption performance is deteriorated, and thus, no super absorbent polymer that satisfies all the required physical properties has been introduced yet.

Therefore, there is a continuous demand for the development of novel super absorbent polymers that maintain the excellent absorption performance of the super absorbent polymers while also having deodorizing effects on various odor-causing substances.

### SUMMARY

The present disclosure aims to provide a super absorbent polymer having both excellent absorption performance and deodorizing effect against odor-causing substances.

The present disclosure provides a super absorbent polymer having a surface area of 45 mm⁻¹ or more relative to an actual volume, and a deodorization rate of 40% or more according to Equation 1 below for dimethyl disulfide (DMDS) or dimethyl trisulfide (DMTS).

$$Deodorization rate ( \% ) = ( 1 - Cs / Co ) \times 100 \qquad [ Equation 1 ]$$

In Equation 1,
Cs is a peak area of an odor standard substance in a gas chromatography-mass spectrometry (GC-MS) graph for an odor standard substance solution that contacted the super absorbent polymer at 35° C. for 2 hours, and Co is a peak area of an odor standard substance in a gas chromatography-mass spectrometry graph for an odor standard substance solution that contacted a control group at 35° C. for 2 hours.

### BRIEF DESCRIPTION OF THE DRAWINGS

Exemplary aspects can be understood in more detail from the following description taken in conjunction with the accompanying drawings, in which:

FIG. 1 shows the setting values of a Sample Dispersion Unit in the morphologi 4 of Malvern Panalytical;

FIG. 2 shows the setting values of an Illumination in the morphologi 4 of Malvern Panalytical;

FIG. 3 shows the setting values of an Optics Selection in the morphologi 4 of Malvern Panalytical; and

FIG. 4 shows the setting values of a Scan Area in the morphologi 4 of Malvern Panalytical.

### DETAILED DESCRIPTION

Unless otherwise defined herein, all technical and scientific terms are used merely to describe exemplary aspects and are not intended to limit the present disclosure. The singular expression includes the plural expression unless the context clearly indicates otherwise. In this specification, the terms “comprise,” “include,” or “have” are intended to specify the presence of a feature, number, step, element, or combination thereof, but should be understood as not excluding in advance the possibility of the presence or addition of one or more other features, numbers, steps, elements, or combinations thereof.

The present disclosure may have various modifications and may take various forms, and thus specific aspects are illustrated and described in detail below. However, this is not intended to limit the present disclosure to a specific disclosed form, but should be understood to include all modifications, equivalents, or alternatives included in the spirit and scope of the present disclosure.

The technical terminology used herein is intended only to refer to specific aspects and is not intended to limit the present disclosure. Also, the singular forms used herein also include the plural forms unless the phrases clearly indicate the opposite meaning.

The term “polymer” used in the specification of the present disclosure means a polymerized state of a water-soluble ethylenically unsaturated monomer and may encompass all moisture content ranges or particle size ranges.

In addition, the term “super absorbent polymer” is used to mean, depending on the context, a base resin in a powder form composed of a crosslinked polymer, super absorbent polymer particles in which the crosslinked polymer is pulverized, or a crosslinked polymer or base resin that has undergone additional processes such as drying, pulverization, classification, surface crosslinking, etc., to make a suitable state for commercialization.

In addition, the term “fine powder” means particles having a particle diameter of less than 150 μm among super absorbent polymer particles. The particle diameter of the polymer particles may be measured according to the European Disposables and Nonwovens Association (EDANA) standard EDANA WSP 220.3 method.

In addition, the term “chopping” refers to cutting a hydrogel polymer into small pieces in the millimeter unit to increase drying efficiency and is used to distinguish from pulverization to the micrometer or normal particle level.

In addition, the term “micronizing or micronization” refers to pulverizing a hydrogel polymer into particle diameters of tens to hundreds of micrometers and is used to distinguish from “chopping”.

In addition, the term “free swelling” refers to a state in which the super absorbent polymer may swell without a restraining load when absorbing a specific solution.

In this specification, element symbols used expressions described in the periodic table.

Hereinafter, a super absorbent polymer and a method for preparing the same according to an aspect of the disclosure will be described in more detail.

I. Polyacrylic Acid (Salt)-based Super Absorbent Polymer

The super absorbent polymer of the present disclosure is a polyacrylic acid (salt)-based super absorbent polymer, characterized in having a surface area of 45 mm⁻¹ or more relative to an actual volume, and a deodorization rate of 40% or more according to Equation 1 below for dimethyl disulfide (DMDS) or dimethyl trisulfide (DMTS).

$$Deodorization rate ( \% ) = ( 1 - Cs / Co ) \times 100 \qquad [ Equation 1 ]$$

In Equation 1 above,
Cs is a peak area of an odor standard substance in a gas chromatography-mass spectrometry (GC-MS) graph for an odor standard substance solution that contacted the super absorbent polymer for 2 hours at 35° C., and Co is a peak area of an odor standard substance in a gas chromatography-mass spectrometry graph for an odor standard substance solution that contacted a control group for 2 hours at 35° C.

The super absorbent polymer of the present disclosure has a surface area of 45 mm⁻¹ or more relative to an actual volume, and thus has a large surface area due to the many curves on the surface of the super absorbent polymer, thereby maintaining excellent absorption performance while at the same time having excellent deodorizing efficacy for various odor-causing substances, especially for dimethyl disulfide or dimethyl trisulfide.

The fact that the super absorbent polymer has a deodorizing effect means that the super absorbent polymer reduces the amount of at least one odor standard substance in the deodorization rate evaluation.

The deodorization rate evaluation is an evaluation in which the super absorbent polymer is brought into contact with an odor standard substance in a physiological saline solution in which the odor standard substance exists, and the specific method of conducting the deodorization rate evaluation will be described in more detail in the experimental example section described below.

The odor standard substance applied to the deodorization rate evaluation includes sulfur compounds such as dimethyl disulfide (DMDS) and dimethyl trisulfide (DMTS), ketones such as diacetyl, and isovaleraldehyde generated from amino acids such as leucine.

The super absorbent polymer according to the present disclosure has an odor reduction effect for dimethyl disulfide (DMDS) or dimethyl trisulfide (DMTS) among the above odor standard substances.

Specifically, the super absorbent polymer according to the present disclosure may have a deodorization rate of 40% or more for dimethyl disulfide (DMDS) or dimethyl trisulfide (DMTS).

For example, the super absorbent polymer according to the present disclosure may have a deodorization rate of 40% or more, 42% or more, or 45% or more for dimethyl disulfide (DMDS) or dimethyl trisulfide (DMTS). Preferably, the deodorization rate of 47% or more, 50% or more, or 52% or more may be exhibited for either dimethyl disulfide (DMDS) or dimethyl trisulfide (DMTS).

In addition, the super absorbent polymer according to the present disclosure may have an odor reduction effect for diacetyl and/or isovaleraldehyde.

That is, the super absorbent polymer according to the present disclosure has a deodorizing effect for dimethyl disulfide (DMDS) or dimethyl trisulfide (DMTS) and in addition, a deodorizing effect for at least one or both of diacetyl and isovaleraldehyde may be exhibited.

In particular, the super absorbent polymer according to the present disclosure may exhibit a deodorizing effect for dimethyl disulfide (DMDS) or dimethyl trisulfide (DMTS) among four odor standard substances, dimethyl disulfide (DMDS), dimethyl trisulfide (DMTS), diacetyl, and isovaleraldehyde, even when all four odor standard substances are mixed, while exhibiting a deodorizing effect for at least one or both of diacetyl and isovaleraldehyde.

The super absorbent polymer according to an aspect of the present disclosure may exhibit in the deodorization rate evaluation, a deodorization rate of 10% or more, 12% or more, or 14% or more for diacetyl among the odor standard substances. There is no particular limitation on the upper limit of the deodorization rate but may be, for example, 100% or less, 95% or less, 90% or less, 85% or less, or 80% or less. The deodorization rate may be exhibited even when all four types of the odor standard substances and the super absorbent polymer are in contact at the same time.

The super absorbent polymer according to an aspect of the present disclosure may exhibit a deodorization rate of 10% or more, 12% or more, or 14% or more for isovaleraldehyde among the odor standard substances in the deodorization rate evaluation. Preferably, a deodorization rate of 16% or more, 18% or more, or 19% or more may be exhibited, and there is no particular limitation on the upper limit of the deodorization rate, but may be, for example, 100% or less, 95% or less, 90% or less, 85% or less, or 80% or less. The deodorization rate may be achieved even when all four types of odor standard substances and the super absorbent polymer are in contact at the same time.

The deodorization rate is a value determined according to Equation 1 below based on the results of the deodorization rate evaluation.

$$Deodorization rate ( \% ) = ( 1 - Cs / Co ) \times 100 \qquad [ Equation 1 ]$$

In Equation 1 above, Cs is a peak area of an odor standard substance in a gas chromatography-mass spectrometry (GC-MS) graph for an odor standard substance solution that contacted the super absorbent polymer according to an aspect of the present disclosure at 35° C. for 2 hours, and Co is a peak area of an odor standard substance in a gas chromatography-mass spectrometry graph for an odor standard substance solution that contacted a control group at 35° C. for 2 hours.

The odor standard substance solution is a solution in which dimethyl disulfide (DMDS), dimethyl trisulfide (DMTS), diacetyl, and isovaleraldehyde are dissolved in a physiological saline solution.

As the control group, GS4800 from LG Chem, a general-purpose super absorbent polymer, was used.

A specific method for evaluating the deodorization rate to confirm the deodorization rate will be described in more detail in the experimental example described below.

The super absorbent polymer according to an aspect of the disclosure may exhibit a deodorization rate of a certain level or higher for dimethyl disulfide (DMDS) or dimethyl trisulfide (DMTS) among the four types of odor standard substances when in contact with all of them at the same time, and at the same time, may exhibit a deodorization rate of a certain level or higher for one or more, or two or more types of odor standard substances other than dimethyl disulfide (DMDS) or dimethyl trisulfide (DMTS).

In an aspect of the present disclosure, the surface area relative to the actual volume of the super absorbent polymer may be 45 mm⁻¹ or more, preferably 46 mm⁻¹ or more. In addition, the surface area relative to the actual volume may be 65 mm⁻¹ or less, preferably 62 mm⁻¹ or less, and more preferably 60 mm⁻¹ or less.

In this specification, the surface area relative to the actual volume means a value obtained by dividing the total surface area of the super absorbent polymer by the total volume of the super absorbent polymer within a specific reference volume.

The surface area relative to the actual volume of the present disclosure is a value obtained by dividing the total surface area of the super absorbent polymer by the total volume of the super absorbent polymer within a specific reference volume. In the present disclosure, a large surface area relative to the actual volume of the super absorbent polymer means that the surface of the super absorbent polymer has many curves and thus has a large surface area.

That is, the present disclosure has a large surface area relative to the actual volume compared to conventional super absorbent polymers, and by having the structure, an absorption path for various fluids may be formed, thereby helping to have excellent absorption performance and deodorizing efficacy for odor-causing substances at the same time.

However, although the larger surface area relative to the actual volume may help to have deodorizing efficacy for odor-causing substances, the surface area relative to the actual volume and the deodorizing efficacy are not necessarily proportional. In other words, a large surface area relative to the actual volume does not necessarily mean a high deodorizing effect, and vice versa.

The surface area relative to the actual volume may be derived using a 3D X-ray microscope (XRM).

In the case of XRM, a cross-sectional image may be obtained by rotating a sample and irradiating X-rays, and three-dimensional data may be obtained based on the image. This is called 3D reconstruction. Conversely, a two-dimensional (2D) cross-sectional image may be extracted from the obtained three-dimensional (3D) data, noise may be removed, a measurement target may be separated, and this may be converted back into three-dimensional (3D) volume data. When the measurement target is separated from the XRM 2D cross-sectional image and converted back into a three-dimensional volume, the measurement target may be precisely observed in a three-dimensional form. In this way, when using XRM, the super absorbent polymer may be analyzed in a three-dimensional or two-dimensional form.

Specifically, the surface area relative to the actual volume may be derived using the method below.

### <Method for Deriving Surface Area Relative to Actual Volume>

### Step 1) Drying and Sampling of Super Absorbent Polymer

A super absorbent polymer is dried at about 100° C. for about 12 hours, and the dried super absorbent polymer is sampled in a size of 1.5 cm×1.5 cm×1.5 cm (width×length×height).

### Step 2) Image Derivation

The sampled super absorbent polymer is analyzed using XRM (ZEISS Xradia 620 Versa) under the conditions below to derive a 3D image of the super absorbent polymer (3D reconstruction).

### <Conditions>

X-Ray Energy: 70 kV
Detector: Flat Pane
Voxel Size: 5 μm
Measurement Time: 0.05 s/frame
Total Images: 4501
   Step 3) Deriving Surface Area to Actual Volume (S_{SAP}/V_{C})

\textcircled{1} Set a region of interest (measurement region) in the 3D reconstructed XRM cross-section 2D image of the super absorbent polymer and cut it out.

\textcircled{2} Apply Gaussian blur to the cut 2D cross-section image to remove noise. Then, convert the 2D cross-section image into a binarization image using Otsu's thresholding method to distinguish the background image and the super absorbent polymer particle image. Repeat for all measurement target 2D images to obtain 2D cross-section images in which the super absorbent polymer particles are separated.

\textcircled{3} Stack the multiple 2D cross-section images and perform 3D rendering.

\textcircled{4} The volume (V_{C}) of the entire super absorbent polymer particles is measured from the 3D rendered volume data. In addition, considering the connectivity of the 3D rendered volume data, the surface area (S_{SAP}) of the super absorbent polymer particle excluding the surface area of a closed pore region is measured. In this case, the area of the outer surface (cut cross-section) of the 3D rendered data is excluded. The surface area (S_{SAP}) of the super absorbent polymer particle is divided by the volume (V_{C}) of the entire super absorbent polymer particles to derive the surface area relative to the actual volume of the super absorbent polymer.

In the process of measuring the surface area relative to the actual volume, the pretreatment of drying the super absorbent polymer at about 100° C. for about 12 hours is performed to measure the surface area relative to the actual volume of the super absorbent polymer without the influence of the moisture content.

The super absorbent polymer according to the present disclosure has excellent absorption performance and may simultaneously have a deodorizing effect on odor-causing substances by comprehensively combining the above-described surface area to actual volume with characteristics such as convexity and CE diameter described below.

In an aspect of the present disclosure, the super absorbent polymer may have an average value of convexity calculated by Equation 2 below for all particles of 0.94 or less.

$${M}_{c} = {L}_{s} / L \qquad [ Equation 2 ]$$

In Equation 2 above,
M_{c} is convexity,
Lₛ means the length of an elastic band when it is assumed that an imaginary elastic band that stretches around an outline surrounds an image captured as a 2D image of a 3D image of a three-dimensional particle to be measured, and
L means the actual perimeter length of the image captured as a 2D image of the 3D image of a three-dimensional particle to be measured.

Convexity is a parameter for measuring the particle outline and the surface roughness of the particle with a value of 0 to 1. The closer the convexity is to 1, the more the particle may be considered to have a very smooth outline, and the closer the convexity is to 0, the more the particle may be considered to have a rough or uneven outline.

The super absorbent polymer according to the present disclosure may have a convexity of 0.94 or less, and a low convexity means a large specific surface area and thus may have an excellent absorption rate.

In this case, the average value of the convexity is derived from the statistical result by randomly scattering on a stage by vacuum within a measuring device and then measuring, confirming n of 200 or more, and obtaining an average.

In an aspect of the present disclosure, the average value of the convexity of the entire particles of the super absorbent polymer may be 0.80 or more, 0.83 or more, 0.85 or more, or 0.87 or more, and 0.94 or less, 0.93 or less, or 0.92 or less.

In an aspect of the present disclosure, the super absorbent polymer may have an average value of the CE diameter (Circle Equivalent diameter) of 220 μm to 450 μm.

The CE diameter refers to the diameter of a circle having the same area as an image captured as a 2D image of a 3D image of a particle, and the size of the particle may be indicated through the CE diameter. The average value of the CE diameter of the super absorbent polymer may be 220 μm or more, 230 μm or more, or 240 μm or more, and 450 μm or less, 440 μm or less, or 430 μm or less.

When the super absorbent polymer according to the present disclosure has the particle size, a super absorbent polymer having a fast absorption rate and excellent absorption characteristics may be prepared.

In addition, the convexity and the CE diameter may be measured using various commercial devices that quantify and analyze the morphologi of the particles based on image analysis of the particles. For example, the parameters may be measured with Malvern Panalytical's morphologi 4, and may be measured specifically by four steps below, which will be described in more detail in the experimental examples described below.
1) Sample preparation: The super absorbent polymer particles to be measured are prepared. In this case, in order to measure the convexity of the particles with a specific range of particle diameters, a sample is prepared by classifying the particles with a specific particle diameter using a Retsch classifier at 1.0 amplitude for 10 minutes.

In this case, the particle diameter of the super absorbent polymer particles may be measured according to the European Disposables and Nonwovens Association (EDANA) standard EDANA WSP 220.3 method.
2) Image acquisition: The prepared sample is set on a stage in the equipment and scanned at 2.5 magnification to acquire images of individual particles.
3) Image processing: For the acquired image, the 3D image of three-dimensional particles for each particle is captured as a 2D image, and parameter values such as the CE diameter (Circle Equivalent diameter), the shortest diameter, the longest diameter, the actual particle perimeter, and the convex hull perimeter are measured.
4) Based on the data analyzed for each particle, a distribution map for the parameters for all particles included in the sample is derived.

In order to obtain the super absorbent polymer of the present disclosure having a deodorization rate higher than a certain value for dimethyl disulfide or dimethyl trisulfide and a surface area value relative to the actual volume higher than a certain value, the inventors adjusted the preparation process conditions of the super absorbent polymer. For example, by controlling the type or content of the additive in the surface crosslinking process, or controlling the polymerization and pulverization process conditions, the super absorbent polymer of the present disclosure may have a deodorization rate higher than a certain value for dimethyl disulfide or dimethyl trisulfide, and at the same time, satisfy a surface area value relative to the actual volume higher than a certain value.

For example, by controlling the type and content of a monomer composition in a polymerization process, the type and content of an internal crosslinking agent, the type, amount, and timing of a surfactant in neutralization and micronization steps, the type, amount, and timing of a neutralizing agent, and the type, rotation speed, hole size, and number of micronizations, the super absorbent polymer may be controlled to have a deodorization rate higher than a certain value for dimethyl disulfide or dimethyl trisulfide, and at the same time, satisfy a surface area value relative to the actual volume higher than a certain value.

Meanwhile, the super absorbent polymer of the present disclosure may have a water retention capacity (CRC) measured according to EDANA method WSP 241.3 of about 28 g/g or more, about 29 g/g or more, or about 30 g/g or more, and about 50 g/g or less, about 45 g/g or less, or about 40 g/g or less.

In addition, the super absorbent polymer of the present disclosure may have an absorbency under pressure (AUP) at 2.07 kPa (0.3 psi) measured according to EDANA method WSP 242.3 of about 25 g/g or more, about 27 g/g or more, about 28 g/g or more, or about 29 g/g or more, and about 45 g/g or less, about 42 g/g or less, or about 40 g/g or less.

The super absorbent polymer of the present disclosure may have a vortex time of 40 seconds or less as measured by a vortex measurement method at 24.0° C.

More specifically, the vortex time may be 40 seconds or less, 39 seconds or less, 38 seconds or less, or 37 seconds or less. In addition, the smaller the value, the vortex time is better, and the lower limit of the vortex time is theoretically 0 seconds but may be, for example, 10 seconds or more.

The methods of measuring the water retention capacity, absorbency under pressure, and absorption rate of the super absorbent polymer will be described in more detail in the experimental examples described below.

In addition, the super absorbent polymer of the present disclosure may have a maximum capacity of water (free swell capacity) that the super absorbent polymer may hold when the super absorbent polymer is swollen in water having an electrical conductivity of 100 to 130 μS/cm for 1 minute, of 130 g or more, 132 g or more, 135 g or more, or 138 g or more, and 230 g or less, 225 g or less, or 220 g or less. This is a numerical value showing the absorption capacity of the super absorbent polymer.

Even when the same super absorbent polymer is used, the absorption behavior in water having an electrical conductivity of 100 to 130 μS/cm and the absorption behavior in 0.9% saline water having an electrical conductivity of about 16,100 μS/cm are different.

That is, it can be said that the absorption capacity, which is the same as the maximum capacity of water, has an independent meaning when using water with an electrical conductivity value of 100 to 130 μS/cm and when using 0.9% saline water with an electrical conductivity of about 16,100 μS/cm.

The inventors of the present disclosure used water with an electrical conductivity of 100 to 130 μS/cm at 24° C., which is lower in ion concentration than the 0.9% saline water and has an electrical conductivity of about 1/100 of the electrical conductivity of 0.9% saline water at 24° C. of about 16,100 μS/cm, to determine the maximum capacity of water that the super absorbent polymer may hold. In the examples, water with an electrical conductivity of 110 μS/cm at 24° C. was used. There is no significant difference in absorption characteristics according to electrical conductivity in the case of water within the range of electrical conductivity of 100 to 130 μS/cm.

Accordingly, the inventors of the present disclosure have attempted to develop a super absorbent polymer having excellent absorption rate and absorption capacity for water having an electrical conductivity of 100 to 130 μS/cm, which has a lower ion concentration and electrical conductivity than 0.9% saline water, that is, an electrical conductivity of about 1/100 of 0.9% saline water, and have achieved by preparing the super absorbent polymer so that it has a deodorization rate of dimethyl disulfide or dimethyl trisulfide of a certain value or higher and at the same time satisfies a surface area to the actual volume value of a certain value or higher.

The method for measuring absorption capacity in water having an electrical conductivity value of 100 to 130 μS/cm will be described in more detail in the experimental examples described below.

Meanwhile, the super absorbent polymer according to the present disclosure may be achieved by appropriately controlling the preparation process conditions such as the component/content of the super absorbent polymer, the polymerization process conditions of the super absorbent polymer, or the pulverizing process conditions. That is, by controlling the process conditions, it is possible to prepare a super absorbent polymer having a deodorization rate higher than a certain value and a surface area value relative to the actual volume higher than a certain value.

For example, by controlling the type and content of a monomer composition in a polymerization process, the type and content of an internal crosslinking agent, the type, amount, and timing of a surfactant in the neutralization and micronization steps, the type, amount, and timing of a neutralizing agent, the type, amount, and timing of a micronization device, the rotation speed, the hole size, the number of micronizations, etc., the super absorbent polymer may be controlled to have a deodorization rate higher than a certain value for dimethyl disulfide or dimethyl trisulfide and a surface area value relative to the actual volume higher than a certain value.

Hereinafter, each component of the super absorbent polymer will be described in more detail.

A polyacrylic acid (salt)-based super absorbent polymer of an aspect of the disclosure includes a base resin including a crosslinked polymer of a water-soluble ethylenically unsaturated monomer having an acidic group and an internal crosslinking agent. The crosslinked polymer may preferably be formed by polymerizing a monomer composition including components such as a monomer, an internal crosslinking agent, and a polymerization initiator.

Here, the water-soluble ethylenically unsaturated monomer may be any monomer commonly used in the preparation of super absorbent polymers. As a non-limiting example, the water-soluble ethylenically unsaturated monomer may be a compound represented by the following Chemical Formula 1:

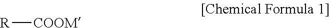

In Chemical Formula 1,
R is an alkyl group having 2 to 5 carbon atoms containing an unsaturated bond, and
M′ is a hydrogen atom, a monovalent or divalent metal, an ammonium group, or an organic amine salt.

Preferably, the monomer may be at least one selected from the group consisting of (meth)acrylic acid, and monovalent (alkali) metal salts, divalent metal salts, ammonium salts, and organic amine salts of the acid.

In this way, when (meth)acrylic acid and/or the salts thereof are used as a water-soluble ethylenically unsaturated monomer, it is advantageous to obtain a super absorbent polymer with improved absorbency. In addition, maleic anhydride, fumaric acid, crotonic acid, itaconic acid, 2-acryloylethane sulfonic acid, 2-methacryloylethane sulfonic acid, 2-(meth)acryloylpropanesulfonic acid or 2-(meth)acrylamide-2-methyl propane sulfonic acid, (meth)acrylamide, N-substituted (meth)acrylate, 2-hydroxyethyl (meth)acrylate, 2-hydroxypropyl (meth)acrylate, methoxypolyethylene glycol (meth)acrylate, polyethylene glycol (meth)acrylate, (N,N)-dimethylaminoethyl (meth)acrylate, (N,N)-dimethylaminopropyl (meth)acrylamide, etc. may be used as the monomer.

The water-soluble ethylenically unsaturated monomer has an acidic group. Meanwhile, in the preparation of super absorbent polymers, a monomer in which at least a portion of the acidic groups are neutralized by a neutralizing agent is crosslinked and polymerized to form a polymer. However, in the present disclosure, preferably, the acidic groups are not neutralized during polymerization but may be neutralized after forming the polymer. More specific details on this will be described in a section on the preparation method of super absorbent polymers.

The concentration of the water-soluble ethylenically unsaturated monomer in the monomer composition may be appropriately adjusted in consideration of the polymerization time and reaction conditions and may be about 20 to about 60 wt %, or about 20 to about 40 wt %.

The term “internal crosslinking agent” used in this specification is a term used to distinguish from a surface crosslinking agent for crosslinking the surface of the super absorbent polymer particles described below, and plays a role in forming a polymer including a crosslinked structure by introducing a crosslinking bond between the unsaturated bonds of the water-soluble ethylenically unsaturated monomers described above.

The crosslinking in the above step is carried out without distinction between the surface and the interior, but when the surface crosslinking process of the super absorbent polymer particle described below is carried out, the surface of the finally prepared super absorbent polymer particle may include a structure newly crosslinked by the surface crosslinking agent, and the interior of the super absorbent polymer particle may maintain the structure crosslinked by the internal crosslinking agent as it is.

According to an aspect of the present disclosure, the internal crosslinking agent may include at least one of a multifunctional acrylate compound, a multifunctional allylic compound, or a multifunctional vinyl compound.

Non-limiting examples of multifunctional acrylate compounds include ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, tripropylene glycol di(meth)acrylate, polypropylene glycol di(meth)acrylate, butanediol di(meth)acrylate, butylene glycol di(meth)acrylate, hexanediol di(meth)acrylate, pentaerythritol di(meth)acrylate, pentaerythritol tri(meth)acrylate, pentaerythritol tetra(meth)acrylate, dipentaerythritol di(meth)acrylate, dipentaerythritol tri(meth)acrylate, dipentaerythritol tetra(meth)acrylate, dipentaerythritol penta(meth)acrylate, trimethylolpropane di(meth)acrylate, trimethylolpropane tri(meth)acrylate, glycerin di(meth)acrylate, and glycerin tri(meth)acrylate, and these may be used alone or in combination of two or more.

Non-limiting examples of polyfunctional allylic compounds include ethylene glycol diallyl ether, diethylene glycol diallyl ether, triethylene glycol diallyl ether, tetraethylene glycol diallyl ether, polyethylene glycol diallyl ether, propylene glycol diallyl ether, tripropylene glycol diallyl ether, polypropylene glycol diallyl ether, butanediol diallyl ether, butylene glycol diallyl ether, hexanediol diallyl ether, pentaerythritol diallyl ether, pentaerythritol triallyl ether, pentaerythritol tetraallyl ether, dipentaerythritol diallyl ether, dipentaerythritol triallyl ether, dipentaerythritol tetraallyl ether, dipentaerythritol pentaallyl ether, trimethylolpropane diallyl ether, trimethylolpropane triallyl ether, glycerin diallyl ether, and glycerin triallyl ether, and may be used alone or in combination of two or more.

Non-limiting examples of polyfunctional vinyl compounds include ethylene glycol divinyl ether, diethylene glycol divinyl ether, triethylene glycol divinyl ether, tetraethylene glycol divinyl ether, polyethylene glycol divinyl ether, propylene glycol divinyl ether, tripropylene glycol divinyl ether, polypropylene glycol divinyl ether, butanediol divinyl ether, butylene glycol divinyl ether, hexanediol divinyl ether, pentaerythritol divinyl ether, pentaerythritol trivinyl ether, pentaerythritol tetravinyl ether, dipentaerythritol divinyl ether, dipentaerythritol trivinyl ether, dipentaerythritol tetravinyl ether, dipentaerythritol pentavinyl ether, trimethylolpropane divinyl ether, trimethylolpropane trivinyl ether, glycerin divinyl ether, and glycerin trivinyl ether, etc. and these may be used alone or in combination of two or more. Preferably, pentaerythritol triallyl ether may be used.

The above-mentioned multifunctional allylic compound or multifunctional vinyl compound may form a crosslinked structure during the polymerization process by bonding two or more unsaturated groups contained in the molecule with the unsaturated bonds of water-soluble ethylenically unsaturated monomers, or the unsaturated bonds of other internal crosslinking agents, and unlike the acrylate compound containing an ester bond (—(C═O)O—) in the molecule, the crosslinked bond may be more stably maintained even during the neutralization process after the polymerization reaction described below.

Accordingly, the gel strength of the super absorbent polymer prepared may be increased, the process stability may be increased during a discharge process after polymerization, and the amount of water-soluble components may be minimized.

The crosslinking polymerization of the water-soluble ethylenically unsaturated monomer in the presence of such an internal crosslinking agent may be performed in the presence of a polymerization initiator, a thickener if necessary, a plasticizer, a preservative stabilizer, an antioxidant, etc.

In the monomer composition, such an internal crosslinking agent may be used in an amount of 0.01 to 5 parts by weight based on 100 parts by weight of the water-soluble ethylenically unsaturated monomer. For example, the internal crosslinking agent may be used in an amount of 0.01 parts by weight or more, 0.05 parts by weight or more, or 0.1 parts by weight or more, and 5 parts by weight or less, 3 parts by weight or less, 2 parts by weight or less, 1 part by weight or less, or 0.7 parts by weight or less relative to 100 parts by weight of the water-soluble ethylenically unsaturated monomer. If the content of the internal crosslinking agent is too low, crosslinking may not occur sufficiently, making it difficult to achieve strength above an appropriate level, and if the content of the internal crosslinking agent is too high, the internal crosslinking density may increase, making it difficult to achieve a desired water retention capacity. In particular, within the range, the super absorbent polymer according to the present disclosure is suitable for achieving such that it has a deodorization rate of a certain value or more for dimethyl disulfide or dimethyl trisulfide and a surface area value to the actual volume of a certain value or more.

Meanwhile, when the content of the internal crosslinking agent is small to ensure that the base resin has high centrifugal retention capacity (CRC), the gel strength of the formed polymer may be low, and the operation of a shredder, etc. may be difficult due to the low gel strength when cutting the hydrogel polymer. In this case, by mixing and using two or more types of internal crosslinking agents for the operation of a high-speed rotary shredder, etc., the gel strength may be increased, thereby improving the operation stability of the shredder, etc.

The formed hydrogel polymer may change a particle shape depending on the degree of internal crosslinking, and the polymer formed using such an internal crosslinking agent may have a three-dimensional network structure in which the main chains formed by polymerizing the water-soluble ethylenically unsaturated monomers are crosslinked by the internal crosslinking agent.

In this way, when the polymer has a three-dimensional network structure, the overall physical properties of the super absorbent polymer, such as the water retention capacity and the absorbency under pressure, may be significantly improved compared to the case of a two-dimensional linear structure that is not additionally crosslinked by the internal crosslinking agent.

The polymer is a polymer in which a monomer and an internal crosslinking agent are polymerized in the presence of a polymerization initiator, and the type of the polymerization initiator is not particularly limited, but preferably, the polymerization may be performed using a thermal polymerization method in a batch reactor, and accordingly, a thermal polymerization initiator may be used as the polymerization initiator.

As the thermal polymerization initiator, one or more selected from the group consisting of initiators consisting of a persulfate-based initiator, an azo-based initiator, hydrogen peroxide, and ascorbic acid may be used. Specifically, examples of a persulfate-based initiator include sodium persulfate (Na₂S₂O₈), potassium persulfate (K₂S₂O₈), and ammonium persulfate ((NH₄)₂S₂O₈), and examples of an azo-based initiator include 2,2-azobis(2-amidinopropane) dihydrochloride, 2,2-azobis-(N,N-dimethylene)isobutylamidine dihydrochloride, 2-(carbamoylazo)isobutylonitrile, 2,2-azobis[2-(2-imidazolin-2-yl)propane]dihydrochloride, 4,4-azobis-(4-cyanovaleric acid), etc. For more diverse thermal polymerization initiators, see Odian's book “Principle of Polymerization (Wiley, 1981),” p. 203, and are not limited to the examples described above.

Such polymerization initiators may be used in an amount of 2 parts by weight or less based on 100 parts by weight of the water-soluble ethylenically unsaturated monomer. In other words, if the concentration of the polymerization initiator is too low, the polymerization rate may be slowed down and a large amount of residual monomer may be extracted from the final product, which is not desirable. On the other hand, if the concentration of the polymerization initiator is higher than the above range, a polymer chain forming a network becomes shorter, which increases the content of the water-soluble component and lowers the absorbency under pressure, which may deteriorate the physical properties of the polymer, which is not preferable.

Meanwhile, in an aspect of the present disclosure, the polymerization initiator and the reducing agent forming a redox couple, are added together to the monomer composition to initiate polymerization.

Specifically, the initiator and reducing agent react with each other to form radicals when added to the polymer solution.

The formed radicals react with the monomer, and since the oxidation-reduction reaction between the initiator and reducing agent has very high reactivity, polymerization is initiated even if only small amounts of the initiator and reducing agent are added, so that there is no need to increase the process temperature, low-temperature polymerization is possible, and changes in the properties of the polymer solution may be minimized.

The polymerization reaction using the oxidation-reduction reaction may occur smoothly even at a temperature near room temperature (25° C.) or less. For example, the polymerization reaction may be performed at a temperature of 5° C. or higher and 25° C. or less, or 5° C. or higher and 20° C. or less.

In an aspect of the present disclosure, when a persulfate-based initiator is used as the initiator, the reducing agent may be at least one selected from the group consisting of sodium metabisulfite (Na₂S₂O₅); tetramethyl ethylenediamine (TMEDA); a mixture (FeSO₄/EDTA) of iron(II) sulfate and EDTA; sodium formaldehyde sulfoxylate; and disodium 2-hydroxy-2-sulfinoacetate.

For example, potassium persulfate may be used as the initiator and disodium 2-hydroxy-2-sulfinoacetate may be used as the reducing agent; ammonium persulfate may be used as the initiator and tetramethyl ethylenediamine may be used as the reducing agent; or sodium persulfate may be used as the initiator and sodium formaldehyde sulfoxylate may be used as the reducing agent.

In another aspect of the present disclosure, when a hydrogen peroxide-based initiator is used as the initiator, the reducing agent may be at least one selected from the group consisting of ascorbic acid; sucrose; sodium sulfite (Na₂SO₃); sodium metabisulfite (Na₂S₂O₅); tetramethyl ethylenediamine (TMEDA); a mixture (FeSO₄/EDTA) of iron(II) sulfate and EDTA; sodium formaldehyde sulfoxylate; disodium 2-hydroxy-2-sulfinoacteate; and disodium 2-hydroxy-2-sulfoacteate.

The monomer composition may further include additives such as a thickener, a plasticizer, a preservative stabilizer, and an antioxidant, as needed.

Also, the monomer composition including the monomer may be in a solution state dissolved in a solvent, for example, water, and the solid content in the monomer composition in the solution state, that is, the concentration of the monomer, the internal crosslinking agent and the polymerization initiator may be appropriately adjusted in consideration of the polymerization time and reaction conditions. For example, the solid content in the monomer composition may be 10 to 80 wt %, 15 to 60 wt %, or 30 to 50 wt %.

The solvent that may be used in this case may be one without limitation as long as it may dissolve the above-mentioned components, and for example, one or more may be used in combination selected from water, ethanol, ethylene glycol, diethylene glycol, triethylene glycol, 1,4-butanediol, propylene glycol, ethylene glycol monobutyl ether, propylene glycol monomethyl ether, propylene glycol monomethyl ether acetate, methyl ethyl ketone, acetone, methyl amyl ketone, cyclohexanone, cyclopentanone, diethylene glycol monomethyl ether, diethylene glycol ethyl ether, toluene, xylene, butyrolactone, carbitol, methyl cellosolve acetate, and N,N-dimethylacetamide.

The polymer obtained by the method may form a polymer having a high molecular weight and uniform molecular weight distribution by polymerizing using an ethylenically unsaturated monomer in an un-neutralized state. Due to this, the content of the water-soluble component is reduced to improve the performance of the super absorbent polymer.

In addition, the polymer may have a moisture content of 30 to 80 wt %. For example, the moisture content of the polymer may be 30 wt % or more, 45 wt % or more, or 50 wt % or more, and 80 wt % or less, 70 wt % or less, or 60 wt % or less.

If the moisture content of the polymer is too low, it may be difficult to secure an appropriate surface area in a subsequent pulverization step, and thus the polymer may not be effectively pulverized. If the moisture content of the polymer is too high, the pressure applied in a subsequent pulverization step may increase, making it difficult to pulverize to a desired particle size.

Meanwhile, throughout this specification, “moisture content” refers to the content of moisture in the total polymer weight, which is a value obtained by subtracting the weight of the polymer in a dry state from the weight of the polymer. Specifically, the moisture content is defined as a value calculated by measuring weight loss due to moisture evaporation in the polymer during the process of drying the polymer in a crumb state by raising the temperature through infrared heating. In this case, the drying condition includes raising the temperature from room temperature to about 180° C. and then maintaining at 180° C. and setting the total drying time to 40 minutes including 5 minutes of the temperature raising step, and the moisture content is measured.

The super absorbent polymer according to an aspect of the disclosure includes a base resin powder including a crosslinked polymer of a water-soluble ethylenically unsaturated monomer having an acidic group and an internal crosslinking agent as described above; a surface crosslinked layer formed on the base resin powder by further crosslinking the crosslinked polymer through a surface crosslinking agent.

The surface crosslinked layer is formed on at least a portion of the surface of the base resin powder and may be formed by additionally crosslinking the crosslinked polymer included in the base resin powder via a surface crosslinking agent.

As the surface crosslinking agent, any surface crosslinking agent that has been used in the production of super absorbent polymers may be used without particular limitation. For example, the surface crosslinking agent may be at least one polyol selected from the group consisting of ethylene glycol, propylene glycol, 1,3-propanediol, 1,4-butanediol, 1,6-hexanediol, 1,2-hexanediol, 1,3-hexanediol, 2-methyl-1,3-propanediol, 2,5-hexanediol, 2-methyl-1,3-pentanediol, 2-methyl-2,4-pentanediol, tripropylene glycol, and glycerol; at least one carbonate compound selected from the group consisting of ethylene carbonate, propylene carbonate, and glycerol carbonate; an epoxy compound such as ethylene glycol diglycidyl ether; an oxazoline compound such as oxazolidinone; a polyamine compound; a mono-, di-, or polyoxazolidinone compound; or a cyclic urea compound; etc.

Specifically, one or more, two or more, or three or more of the surface crosslinking agents described above may be used as the surface crosslinking agent, for example, ethylene carbonate-propylene carbonate (ECPC), propylene glycol, and/or glycerol carbonate may be used.

Such a surface crosslinking agent may be used in an amount of 0.001 to 0.5 parts by weight based on 100 parts by weight of the super absorbent polymer particles. In this case, 100 parts by weight of the super absorbent polymer particles are based on a dried state. In addition, the content means the total amount of the surface crosslinking agent used.

For example, the surface crosslinking agent may be used in an amount of 0.005 parts by weight or more, 0.01 parts by weight or more, or 0.05 parts by weight or more relative to 100 parts by weight of the super absorbent polymer particles. In addition, the surface crosslinking agent may be used in an amount of 3.0 parts by weight or less, 2.5 parts by weight or less, 2.0 parts by weight or less, 1.5 parts by weight or less, 1.0 part by weight or less, 0.5 parts by weight or less, 0.4 parts by weight or less, or 0.2 parts by weight or less relative to 100 parts by weight of the super absorbent polymer particles.

By adjusting the content range of the surface crosslinking agent to the above-described range, a super absorbent polymer exhibiting excellent overall absorption properties may be prepared. In particular, within the range, the super absorbent polymer according to the present disclosure is suitable for achieving a deodorization rate higher than a certain value for dimethyl disulfide or dimethyl trisulfide and at the same time a surface area value relative to the actual volume higher than a certain value.

In addition, the surface crosslinked layer may be formed by adding an inorganic material to the surface crosslinking agent. That is, in the presence of the surface crosslinking agent and the inorganic material, the surface of the base resin powder may be further crosslinked to form a surface crosslinked layer.

As the inorganic material, one or more inorganic materials selected from the group consisting of silica, clay, alumina, silica-alumina composite, titania, zinc oxide, and aluminum sulfate may be used. The inorganic materials may be used in powder form or liquid form, and in particular, may be used as alumina powder, silica-alumina powder, titania powder, or nano silica solution. In addition, the inorganic material may be used in an amount of about 0.001 to 1 parts by weight relative to 100 parts by weight of the super absorbent polymer particles.

As described above, the super absorbent polymer including the base resin powder and the surface crosslinked layer formed on the base resin powder may absorb body fluid or water at a high rate, and may also absorb a relatively large amount initially, thereby preventing problems such as body fluid or water not being absorbed and accumulating or leaking out.

### II. Preparation Method of Super Absorbent Polymer

The conventional super absorbent polymers are prepared by crosslinking and polymerizing a water-soluble ethylenically unsaturated monomer having at least a partially neutralized acid group in the presence of an internal crosslinking agent and a polymerization initiator to form a hydrogel polymer, drying the hydrogel polymer formed in this manner, and then pulverizing to a desired particle size. In this case, a chopping process is usually performed to cut the hydrogel polymer into particles with several millimeters in size before the drying process to facilitate drying of the hydrogel polymer and increase the efficiency of the pulverizing process. However, due to the adhesiveness of the hydrogel polymer in this chopping process, the hydrogel polymer is not pulverized to a micro-sized particle level and becomes an aggregated gel. When this aggregated gel-shaped hydrogel polymer is dried, a plate-shaped dried product is formed, and in order to pulverize to a micro-sized particle level, a multi-stage pulverizing process is required to be performed to reduce the adhesiveness of the polymer, causing a problem of generating a lot of fine powders during this process.

To solve the problem, a method of reusing the separated fine particles by mixing them with an appropriate amount of water and reassembling the fine particles and then adding them to the chopping step or pre-drying step has been used. However, problems such as increased device load and/or energy usage have occurred during the process of reusing the fine particles. In addition, the physical properties of the super absorbent polymer was deteriorated due to the fine particles that were not classified and remained even after reuse.

In order to solve the problem, as a result of repeated research, it was confirmed that, instead of performing polymerization in a state where the acid group of the water-soluble ethylenically unsaturated monomer is neutralized, as in the conventional method for preparing a super absorbent polymer, polymerization is first performed in a state where the acid group is not neutralized to form a polymer, and then the hydrogel polymer is micronized in the presence of a surfactant and then the acid group of the polymer is neutralized, or the acid group of the polymer is neutralized to form a hydrogel polymer and then the hydrogel polymer is micronized in the presence of a surfactant, or the acid group present in the polymer is neutralized simultaneously with the micronization, so that the surfactant is present in a large amount on the surface of the polymer and may sufficiently play a role in lowering the high adhesiveness of the polymer, preventing the polymer from excessively aggregating, and controlling the aggregation state to a desired level.

Meanwhile, the super absorbent polymer according to the present disclosure may be achieved by controlling the resin component and content, polymerization conditions, pulverization process conditions, etc. For example, by controlling the type and content of the monomer composition in the polymerization process, the type and content of the internal crosslinking agent, the type, amount and timing of injection of the surfactant in the neutralization and micronization steps, the type, amount and timing of injection of the neutralizing agent, the type of micronization device, the rotation speed, the hole size, the number of micronizations, the components and content of the surface crosslinking solution, etc., the super absorbent polymer may be controlled to have a deodorization rate for dimethyl disulfide or dimethyl trisulfide of a certain value or higher and a surface area to an actual volume value of a certain value or higher.

In particular, when conducting a polymerization process, a micronization method, and a surface crosslinking process in the preparation process of a super absorbent polymer, the super absorbent polymer may be controlled to have a deodorization rate for dimethyl disulfide or dimethyl trisulfide of a certain value or higher and a surface area to an actual volume value of a certain value or higher by controlling the neutralization time and polymerization conditions, applying an ultrafine chain process or not, controlling the components and content of the surface crosslinking solution, controlling the hole size, or controlling the number of micronizations.

Hereinafter, a method for preparing a super absorbent polymer according to an aspect will be described in more detail for each step.

### Step 1: Polymerization Step

First, polymerization is performed on a monomer composition containing a water-soluble ethylenically unsaturated monomer having an acid group and an internal crosslinking agent, thereby producing a base resin powder containing a polymer in which the water-soluble ethylenically unsaturated monomer having an acid group and the internal crosslinking agent are crosslinked and polymerized.

The step may be composed of a step of preparing a monomer composition by mixing the water-soluble ethylenically unsaturated monomer having an acid group, an internal crosslinking agent, and a polymerization initiator, and a step of polymerizing the monomer composition to form a polymer.

Here, the contents of each component described in the super absorbent polymer of item I described above may all be applied equally.

Meanwhile, the water-soluble ethylenically unsaturated monomer has an acid group. As described above, in the production of the conventional super absorbent polymers, a monomer in which at least a portion of the acid groups is neutralized by a neutralizing agent is crosslinked and polymerized to form a polymer. Specifically, in the step of mixing the water-soluble ethylenically unsaturated monomer having an acid group, the internal crosslinking agent, the polymerization initiator, and the neutralizing agent, at least a portion of the acid groups of the water-soluble ethylenically unsaturated monomer was neutralized.

However, according to an aspect of the present disclosure, polymerization is first performed in a state in which the acid groups of the water-soluble ethylenically unsaturated monomer are not neutralized to form a polymer.

A water-soluble ethylenically unsaturated monomer (e.g., acrylic acid) in which the acid groups are not neutralized, is in a liquid state at room temperature and has high miscibility with a solvent (water), so it exists in a state of a mixed solution in a monomer composition. However, a water-soluble ethylenically unsaturated monomer in which the acid groups are neutralized, is in a solid state at room temperature and has different solubility depending on the temperature of the solvent (water), and the solubility decreases at a lower temperature.

In this way, the water-soluble ethylenically unsaturated monomer in which the acid group is not neutralized has a higher solubility or miscibility in a solvent (water) than the monomer in which the acid group is neutralized, so that precipitation does not occur even at a low temperature, and long-term polymerization is advantageous at a low temperature. Accordingly, by performing long-term polymerization using the water-soluble ethylenically unsaturated monomer in which the acid group is not neutralized, a polymer having a higher molecular weight and uniform molecular weight distribution may be stably formed.

In addition, since the formation of a polymer with a longer chain is possible, the effect of reducing the content of water-soluble components that are not crosslinked due to incomplete polymerization or crosslinking may be achieved, and accordingly, the super absorbent polymer is suitable for achieving a surface area value to a certain value or higher while having a deodorization rate for dimethyl disulfide or dimethyl trisulfide or a surface area value to a certain volume or higher.

In addition, if polymerization is first performed in a state where the acid group of the monomer is not neutralized to form a polymer, and then the polymer is micronized in the presence of a surfactant after neutralization or micronized in the presence of a surfactant and then neutralized, or the acid group present in the polymer is neutralized at the same time as the micronization, the surfactant may sufficiently play a role in reducing the adhesiveness of the polymer by being present in a large amount on the surface of the polymer.

According to an aspect of the present disclosure, the step of performing polymerization on the monomer composition to form a polymer may be performed in a batch type reactor for 1 hour or more.

In a typical method for preparing a super absorbent polymer, the polymerization method is largely divided into thermal polymerization and photopolymerization depending on the polymerization energy source. When thermal polymerization is performed, the polymerization may be performed in a reactor having a stirring shaft such as a kneader, and when photopolymerization is performed, the polymerization may be performed in a flat-bottomed container.

Meanwhile, when the polymerization is performed as a continuous polymerization, for example, when the polymerization is performed in a reactor equipped with a conveyor belt, a new monomer composition is supplied to the reactor as the polymerization resultant moves, so that the polymerization is performed continuously, and thus, polymers with different polymerization rates are mixed, and accordingly, it is difficult to achieve even polymerization throughout the monomer composition, which may result in a deterioration of overall physical properties.

However, according to an aspect of the present disclosure, since the polymerization is performed in a stationary manner in a batch reactor, there is less concern that polymers with different polymerization rates may be mixed, and accordingly, a polymer with even quality may be obtained.

In addition, the polymerization step is performed in a batch reactor having a predetermined volume, and the polymerization reaction is performed for a longer period of time, for example, 1 hour or more, 3 hours or more, or 6 hours or more, than when the polymerization is performed continuously in a reactor equipped with a conveyor belt. Despite the long polymerization reaction time as described above, since polymerization is performed on a water-soluble ethylenically unsaturated monomer in an un-neutralized state, the monomer is not easily precipitated even if polymerization is performed for a long time, and therefore, it is advantageous for long-term polymerization.

Meanwhile, since polymerization in the batch reactor of the present disclosure uses a thermal polymerization method, the polymerization initiator uses a thermal polymerization initiator, and the description of the corresponding component is as described above.

### Steps 2 and 3: Micronization and Neutralization Steps

Next, a step (step 2) for producing a mixture containing micronized hydrogel polymer by micronizing the hydrogel polymer in the presence of a surfactant is included.

The micronization step is a step for micronizing the polymer in the presence of a surfactant and is a step in which micronization and aggregation into a size of tens to hundreds of micrometers are simultaneously performed, rather than chopping the polymer into a size of millimeters.

That is, the step is for producing secondary aggregated particles in the form of aggregates of primary particles micronized into a size of tens to hundreds of micrometers by imparting appropriate adhesiveness to the polymer. The secondary aggregated particles, hydrogel super absorbent polymer particles, prepared by this step have normal particle size distribution and a greatly increased surface area, so that the absorption rate may be significantly improved.

Meanwhile, in the micronization step, when a high-intensity mechanical shear force is applied and the polymer is ultra-finely pulverized at a rotation speed of 500 rpm to 4,000 rpm, aggregated hydrogel particles having finer pores may be formed.

In this case, when the polymer is ultra-finely pulverized at a rotation speed of 500 rpm to 4,000 rpm, since a high-intensity mechanical shear force is applied, fine pores of 100 μm or less are easily formed in the polymer, thereby increasing the surface roughness, and the total surface area of the polymer is significantly increased by the pores formed inside and outside the polymer particles. Since the fine pores are formed in a stable form compared to the pores formed using a foaming agent in the polymerization step, the degree of fine powder generation by the pores may be significantly reduced in the subsequent process. The super absorbent polymer particles prepared by the steps may have a significantly increased surface area, so that the absorption rate may be significantly improved, and accordingly, the super absorbent polymer of the present disclosure is suitable for achieving a surface area value relative to the actual volume of a predetermined value or higher while having a deodorization rate of a certain value or higher for dimethyl disulfide or dimethyl trisulfide.

The ultrafine pulverization process is performed at a rotation speed of 500 rpm to 4,000 rpm. If the rotation speed of the process is less than 500 rpm, it is difficult to form sufficient pores to the desired degree, so it is difficult to expect a fast absorption rate and to secure the desired level of productivity. In addition, if the speed exceeds 4,000 rpm, a polymer chain may be damaged due to excessive shear force, and accordingly, water-soluble components may increase, so that the overall physical properties of the prepared super absorbent polymer may be somewhat deteriorated. Preferably, the ultra-fine pulverization process may be performed at 1,000 rpm to 3,500 rpm, or 2,000 rpm to 3,000 rpm. In this range, the desired micropore formation is easily achieved without the aforementioned problems.

According to an aspect of the present disclosure, the micronization step is performed by a micronization device, and the micronization device may include a body part including a transport space in which a polymer is transported therein; a screw member rotatably installed inside the transport space to move the polymer; a driving motor providing a rotational driving force to the screw member; a cutter member installed in the body part to pulverize the polymer; and a porous plate having a plurality of holes formed therein for discharging the polymer pulverized by the cutter member to the outside of the body part.

In this case, the hole size provided in the porous plate of the micronization device may be 1 mm to 25 mm, 5 mm to 20 mm, or 5 mm to 15 mm.

In this way, when the polymer mixed with the surfactant is micronized while controlling aggregation using a micronization device, smaller particle size distribution is realized, so that subsequent drying and pulverizing processes may be performed under milder conditions, thereby preventing fine dust generation and improving the properties of the super absorbent polymer. In addition, if ultra-fine pulverization is performed, appropriate micropores are simultaneously formed on the surface of the polymer, thereby improving the absorption rate through an increase in surface area.

The micronization step may be performed once or more times, and preferably once to six times, or once to four times, or once to three times. The micronization step may be performed using a plurality of micronizing devices, or may be performed using a single micronizing device including a plurality of porous plates and/or a plurality of cutter members, or among the plurality of micronizing devices, some devices may include a plurality of porous plates and/or a plurality of cutter members.

According to an aspect of the present disclosure, a surfactant may be additionally used in the micronization step, and thus, the aggregation between polymer particles is effectively controlled, thereby reducing the load on the device used in the pulverization process and further improving productivity.

Preferably, the surfactant may be a compound represented by the following Chemical Formula 2 or a salt thereof, but the present disclosure is not limited thereto:

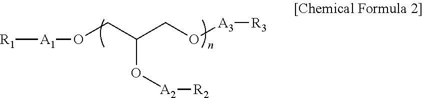

In Chemical Formula 2,
A₁, A₂ and A₃ are each independently a single bond, carbonyl,

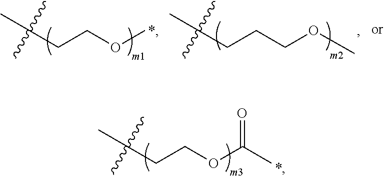

provided that at least one of them is carbonyl or

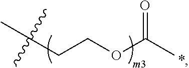

where m1, m2 and m3 are each independently an integer from 1 to 8,

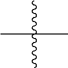

are each connected to an adjacent oxygen atom, [symbol] are each connected to adjacent R₁, R₂ and R₃,
R₁, R₂ and R₃ are each independently hydrogen, a linear or branched chain alkyl having 6 to 18 carbon atoms or a linear or branched chain alkenyl having 6 to 18 carbon atoms, and
n is an integer from 1 to 9.

The surfactant is added so that the micronization step may be easily performed without aggregation by mixing with the polymer.

The surfactant represented by Chemical Formula 2 is a nonionic surfactant and has excellent surface adsorption performance due to hydrogen bonding even with an un-neutralized polymer, and is therefore suitable for achieving the desired aggregation control effect. On the other hand, in the case of an anionic surfactant, not a nonionic surfactant, when mixed with a polymer neutralized with a neutralizing agent such as NaOH or Na₂SO₄, the surfactant is adsorbed via the Na⁺ ion ionized in the carboxyl group substituent of the polymer, and when mixed with an un-neutralized polymer, there is a problem that the adsorption efficiency for the polymer is relatively lowered due to competition with the anion of the carboxyl group substituent of the polymer.

Specifically, in the surfactant represented by Chemical Formula 2, the hydrophobic functional group corresponds to the terminal functional groups of R₁, R₂, and R₃ moieties (if not hydrogen), and the hydrophilic functional group further includes a glycerol-derived moiety within the chain and a terminal hydroxyl group (if Aₙ is a single bond and Rₙ is hydrogen at the same time, n=1 to 3), and the glycerol-derived moiety and the terminal hydroxyl group serve as hydrophilic functional groups to improve the adsorption performance on the polymer surface. Accordingly, the aggregation of super absorbent polymer particles may be effectively suppressed.

In Chemical Formula 2, the hydrophobic functional groups of R₁, R₂, and R₃ moieties (if not hydrogen) are each independently linear or branched alkyl having 6 to 18 carbon atoms or linear or branched alkenyl having 6 to 18 carbon atoms. In this case, if R₁, R₂, and R₃ moieties (if not hydrogen) are alkyl or alkenyl having less than 6 carbon atoms, there is a problem that the aggregation control of the pulverized particles is not effectively achieved due to the short chain length, and if R₁, R₂, and R₃ moieties (if not hydrogen) are alkyl or alkenyl having more than 18 carbon atoms, the mobility of the surfactant may be reduced and may not be effectively mixed with the polymer, and there may be a problem that the unit price of the composition increases due to the increase in the cost of the surfactant.

Preferably, R₁, R₂, and R₃ are hydrogen, or when they are linear or branched chain alkyl having 6 to 18 carbon atoms, may be 2-methylhexyl, n-heptyl, 2-methylheptyl, n-octyl, n-nonyl, n-decanyl, n-undecanyl, n-dodecanyl, n-tridecanyl, n-tetradecanyl, n-pentadecanyl, n-hexadecanyl, n-heptadecanyl, or n-octadecanyl, or when they are linear or branched chain alkenyl having 6 to 18 carbon atoms, may be 2-hexenyl, 2-heptenyl, 2-octenyl, 2-nonenyl, n-decenyl, 2-undekenyl, 2-dodekenyl, 2-tridekenyl, 2-tetradekenyl, 2-pentadekenyl, 2-hexadekenyl, 2-heptadekenyl, or 2-octadekenyl.

The surfactant may be selected from the compounds represented by the following Chemical Formulas 2-1 to 2-14, but is not limited thereto:

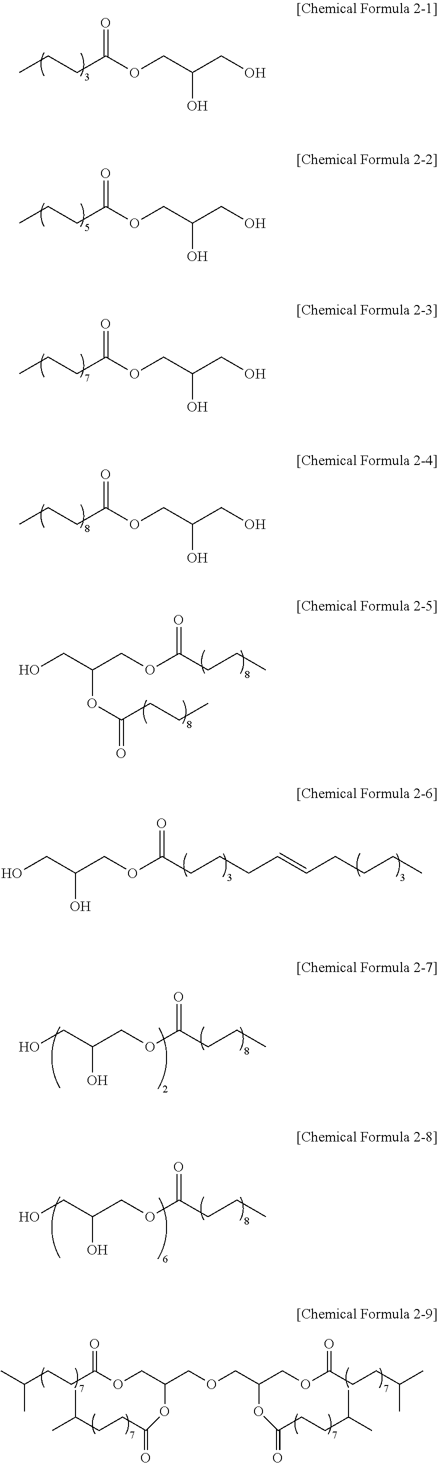

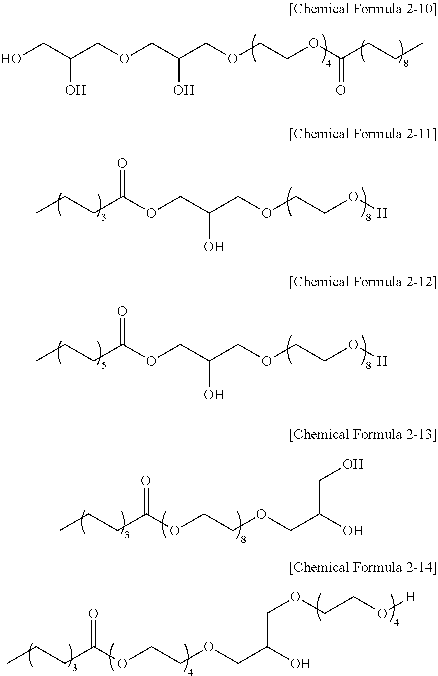

Meanwhile, the amount of the surfactant used is not particularly limited but may be 0.06 g to 0.48 g per 1,000 g of the hydrogel polymer depending on the productivity or the device load status.

If the surfactant is used too little, the surfactant may not be evenly adsorbed on the polymer surface, causing re-aggregation of particles after pulverization, or absorption performance such as water retention capacity and absorbency under pressure may be deteriorated due to the surfactant sharing a lot with the polymer. Meanwhile, if the surfactant is used too much, the overall physical properties of the finally prepared super absorbent polymer may be deteriorated due to a decrease in surface tension.

Therefore, for example, the surfactant may be used in an amount of 0.06 g or more, 0.1 g or more, or 0.2 g or more, but 0.48 g or less, 0.45 g or less, or 0.4 g or less per 1,000 g of the hydrogel polymer. In this case, it is easy to control the super absorbent polymer to have a deodorization rate higher than a certain value for dimethyl disulfide or dimethyl trisulfide and a surface area to an actual volume value higher than a certain value.

The method of mixing the surfactant into the polymer is not particularly limited as long as it is a method that may evenly mix into the polymer and may be appropriately adopted and used. Specifically, the surfactant may be mixed in a dry manner, mixed in a solution state after dissolving in a solvent, or mixed after melting the surfactant.

For example, the surfactant may be mixed in a solution state dissolved in a solvent. In this case, any type of solvent may be used without limitation, including inorganic or organic solvents, but water is most appropriate when considering the ease of the drying process and the cost of a solvent recovery system. In addition, the solution may be used by mixing the surfactant and the polymer in a reaction tank, adding the polymer to a mixer and spraying the solution, or continuously supplying the polymer and the solution to a continuously operating mixer and mixing them.

Meanwhile, when the surfactant is mixed in a solution state dissolved in water, the surfactant may be used by diluting with an aqueous solution having a concentration of about 0.01% to 90%.

For example, when the surfactant is to be used at 0.1 g per 1,000 g of the hydrogel polymer, 100 g of an aqueous solution having a concentration of 0.1% in which 0.1 g of the surfactant is dissolved in 99.9 g of water may be used. Alternatively, 10 g of an aqueous solution having a concentration of 1% in which 0.1 g of the surfactant is dissolved in 9.9 g of water may be used.

That is, when the same amount of surfactant is used, the water content may be increased or decreased to use an aqueous solution having a desired concentration, and the concentration may be appropriately adjusted in consideration of the physical properties of the super absorbent polymer to be finally prepared.

According to an aspect of the disclosure, a step (step 3) of neutralizing at least a portion of the acidic groups of the polymer is performed, and the micronization step of step 2 and the neutralization step of step 3 described above may be performed sequentially, alternately, or simultaneously.

That is, a neutralizing agent may be added to the polymer to neutralize the acidic group first, and then a surfactant may be added to the neutralized polymer to micronize the polymer mixed with the surfactant (performed in the order of step 3→step 2), or the neutralizing agent and the surfactant may be added to the polymer simultaneously to perform neutralization and micronization of the polymer (perform steps 2 and 3 simultaneously). Alternatively, the surfactant may be added first, and the neutralizing agent may be added later (performed in the order of step 2→step 3). Alternatively, the neutralizing agent and the surfactant may be alternately added in an alternation manner. Alternatively, the surfactant may be injected first to micronize, the neutralizing agent may be injected to neutralize, and the surfactant may be additionally injected into the neutralized hydrogel polymer to perform an additional micronization process.

Here, if the neutralization step is performed independently from the micronization step of step 2, the process may be performed in a manner in which the polymer is pulverized while the additive is simultaneously injected. More specifically, a screw-type extruder including a porous plate having a plurality of holes formed therein may be used. The screw-type extruder is a device that performs pulverization under mild conditions compared to the micronization device used in the micronization step described above, and the rotation speed may be about 150 rpm to 500 rpm, and the holes of the porous plate may be about 3 mm to 25 mm, but are not limited thereto.

The rotation speed of the screw-type extruder and the size of the holes of the porous plate affect the discharge state of the super absorbent polymer discharged from the extruder, and the particle shape of the super absorbent polymer may change depending on the discharge state.

In particular, by controlling the rotation speed of the screw-type extruder to 150 rpm to 500 rpm, the super absorbent polymer may be controlled to have a deodorization rate higher than a certain value for dimethyl disulfide or dimethyl trisulfide and a surface area value to an actual volume higher than a certain value.

In this case, a basic material such as sodium hydroxide, potassium hydroxide, or ammonium hydroxide that may neutralize acid groups may be used as the neutralizing agent.

In addition, the degree of neutralization, which refers to the degree of neutralization of acid groups included in the polymer by the neutralizing agent, may be 50 to 90 mol %, 60 to 85 mol %, 65 to 85 mol %, or 65 to 80 mol %. The range of the degree of neutralization may vary depending on the final physical properties, and the absorption speed and absorption performance may be controlled by controlling the degree of neutralization.

In this case, if the degree of neutralization is too high, the absorption capacity of the super absorbent polymer may decrease, and if the concentration of carboxyl groups on the particle surface is too low, it is difficult to properly perform surface crosslinking in the subsequent process, which may decrease the absorbency characteristics under pressure or liquid permeability. On the other hand, if the degree of neutralization is too low, the absorption capacity of the polymer may decrease significantly, and properties like elastic rubber that are difficult to handle may be shown.

Meanwhile, in order to evenly neutralize the entire polymer, it may be desirable to leave a certain amount of time between the injection of the neutralizing agent and the micronization process.

### Step 4: Drying Step

Next, a step (step 4) of drying the micronized and neutralized polymer to prepare a base resin powder is performed.

The step is a step of drying the moisture of the base resin powder which is a polymer obtained by neutralizing at least a portion of the acid groups of the polymer and micronizing the polymer.

In the conventional method for preparing a super absorbent polymer, the drying step is performed so that the moisture content of the base resin powder becomes about 4 to 20 wt %, about 4 to 15 wt %, or about 6 to 13 wt %. However, the present disclosure is not limited thereto.

Step 4 may be performed in a fixed-bed type drying manner, a moving type drying manner, or a combination thereof.

According to an aspect of the disclosure, step 4 may be performed in a fixed-bed type drying manner.

Static drying refers to a method in which a material to be dried is stopped on a porous iron plate that allows air to pass through, and the material is dried by passing hot air from the bottom to the top.

Since static drying dries in a plate-like shape without particle movement, it is difficult to perform uniform drying with a simple flow of hot air. Therefore, static drying requires delicate control of hot air and temperature to obtain a uniform dried product with a high moisture content. In the present disclosure, the method of changing the hot air from the bottom to the top prevents the plate-like dried product from bending during drying, thereby preventing the hot air from leaking out. In addition, the drying temperature is changed by section so that the upper, middle, and lower layers inside the dried product may be uniformly dried with a moisture content deviation of less than 5%.

As a device capable of drying by a static drying method, a belt-type dryer, etc. may be used, but is not limited thereto.

In the case of the static drying step, the drying process may be performed at a temperature of about 80° C. to 200° C., preferably 90° C. to 190° C. or 100° C. to 180° C. If the drying temperature is less than 80° C., the drying time may be excessively long, and if the drying temperature is excessively high, exceeding 200° C., a super absorbent polymer having a moisture content lower than the desired moisture content may be obtained. Meanwhile, the drying temperature may refer to the temperature of the hot air used or may refer to the internal temperature of the device during the drying process.

According to an aspect of the disclosure, step 4 may be performed by fluid drying.

The fluid drying refers to a method of drying while mechanically stirring the dried product during drying. In this case, the direction in which the hot air passes through the material may be the same as or different from the circulation direction of the material. Alternatively, the material may be dried by circulating the heat-release fluid (heat-release oil) inside the dryer and passing through a separate pipe outside the dryer.

As a device capable of drying by this fluid drying method, a horizontal-type mixer, a rotary kiln, a paddle dryer, a steam tube dryer, or a generally used fluid dryer may be used.

In the case of the fluid drying step, the drying process may be performed at a temperature of about 100° C. to 300° C., preferably 120° C. to 280° C. or 150° C. to 250° C. If the drying temperature is too low, less than 100° C., the drying time may be too long, and if the drying temperature is too high, exceeding 300° C., the polymer chain of the super absorbent polymer may be damaged, which may result in a decrease in overall physical properties, and a super absorbent polymer having a moisture content lower than the desired moisture content may be obtained.

### Step 5: Pulverization Step

Next, a step of pulverizing the dried base resin powder is performed.

Specifically, the pulverization step may be performed to pulverize the dried base resin powder to have a particle size of a normal particle level, that is, a particle size of 150 μm to 850 μm.

The pulverizer used for this purpose may specifically be a vertical pulverizer, a turbo cutter, a turbo grinder, a rotary cutter mill, a cutter mill, a disc mill, a shred crusher, a crusher, a chopper, or a disc cutter, and is not limited to the examples described above.

Alternatively, a pin mill, a hammer mill, a screw mill, a roll mill, a disc mill, or a jog mill may be used as a pulverizer but is not limited to the examples described above.

Meanwhile, in the preparation method of the present disclosure, super absorbent polymer particles having smaller particle size distribution than those in the conventional chopping step may be realized in the micronization step, and since the moisture content after drying is maintained relatively high, even if pulverization is performed under mild conditions with a less pulverizing force, a super absorbent polymer having a very high content of normal particle size of 150 μm to 850 μm may be formed, and the fine powder generation ratio may be greatly reduced.

The super absorbent polymer particles prepared as described above may contain super absorbent polymer particles, i.e., normal particles, having a particle diameter of 150 μm to 850 μm, in an amount of 80 wt % or more, 85 wt % or more, 89 wt % or more, 90 wt % or more, 92 wt % or more, 93 wt % or more, 94 wt % or more, or 95 wt % or more based on the total weight. The particle diameter of the polymer particles may be measured according to the European Disposables and Nonwovens Association (EDANA) standard EDANA WSP 220.3 method.

In addition, the super absorbent polymer particles may include fine particles having a particle diameter of less than 150 μm in an amount of about 20 wt % or less, about 18 wt % or less, about 15 wt % or less, about 13 wt % or less, about 12 wt % or less, about 11 wt % or less, about 10 wt % or less, about 9 wt % or less, about 8 wt % or less, or about 5 wt % or less relative to the total weight. This is in contrast to a case where a super absorbent polymer is prepared using the conventional preparation method and has a fine particle content of greater than about 20 wt % to about 30 wt %.

### Additive Injection Step

Meanwhile, according to an aspect of the disclosure, a step of adding an additive to the micronized and neutralized polymer before the drying step (step 4) may be further included.

The additive injection process is a process for improving physical properties by using an additional additive within a range that does not hinder the desired effect, and the type of the additive is not particularly limited. The examples thereof include, but are not limited to, a polymerization initiator for removing residual monomers, a permeability improving agent for improving absorption properties, a fine powder anti-caking agent for recycling the generated fine powder, a fluidity improving agent, an antioxidant, a neutralizing agent, a surfactant, etc.

The additive injection step may be performed simultaneously with step 2, simultaneously with step 3, after steps 2 and 3, or in at least one or more of the steps. The additive injection step may be performed multiple times as needed and may also be performed at least once in each step.

If the additive injection step is performed independently from steps 2 and 3, that is, after steps 2 and 3 and before step 4, it may be performed in a manner in which the additive is injected while pulverizing the polymer.

The pulverization may be applied in the same manner as the pulverization step of step 5 described above, and the additive may be injected once or multiple times in the pulverization step and mixed with the polymer.

### Classification Step

Next, after the step of pulverizing the base resin powder (step 5), a step of classifying the pulverized super absorbent polymer particles according to particle diameters may be further included.

### Surface Crosslinking Step

In addition, after pulverizing (step 5) and/or classifying the base resin powder, a step of forming a surface crosslinked layer on at least a portion of the surface of the base resin particles in the presence of a surface crosslinking agent may be further included. By the step, the crosslinked polymer contained in the base resin powder may be further crosslinked via the surface crosslinking agent, so that a surface crosslinked layer may be formed on at least a portion of the surface of the base resin powder.

The description of the surface crosslinking agent may be applied equally to all of the above-mentioned contents.

In addition, there is no limitation on the configuration of the method of mixing the surface crosslinking agent with the base resin powder. For example, a method of mixing a composition including a surface crosslinking agent and a base resin powder in a reaction tank, a method of spraying a surface crosslinking agent onto the composition, a method of continuously supplying a resin composition and the surface crosslinking agent to a continuously operated mixer, etc. may be used.

When mixing the surface crosslinking agent and the base resin powder, water and methanol may be additionally mixed and added. When adding water and methanol, there is an advantage in that the surface crosslinking agent may be evenly dispersed in the resin composition. In this case, the contents of the added water and methanol may be appropriately adjusted to induce even dispersion of the surface crosslinking agent, prevent aggregation of the resin composition, and optimize the surface penetration depth of the crosslinking agent.

The surface crosslinking process may be performed at a temperature of about 80° C. to about 250° C. More specifically, the surface crosslinking process may be performed at a temperature of about 100° C. to about 220° C., or about 120° C. to about 200° C. for about 20 minutes to about 2 hours, or about 40 minutes to about 80 minutes. When the surface crosslinking process conditions are satisfied, the surface of the super absorbent polymer particles may be sufficiently crosslinked, thereby increasing the absorbency under pressure.

The temperature increasing means for the surface crosslinking reaction is not particularly limited.

Heating may be performed by supplying a heat medium or directly supplying a heat source. In this case, the type of heat medium that may be used includes heated fluids such as steam, hot air, and hot oil, but is not limited thereto, and the temperature of the supplied heat medium may be appropriately selected in consideration of the means of the heat medium, the heating rate, and the target temperature of the heating. Meanwhile, as a directly supplied heat source, heating through electricity and heating through gas may be illustrated but is not limited to the examples described above.

### Post-Processing Step

According to an aspect of the present disclosure, after the step of forming a surface crosslinked layer on at least a portion of the surface of the base resin powder, at least one of a cooling step of cooling the super absorbent polymer particles on which the surface crosslinked layer is formed, a watering step of adding water to the super absorbent polymer particles on which the surface crosslinked layer is formed, and a post-processing step of adding an additive to the super absorbent polymer particles on which the surface crosslinked layer is formed, may be further performed. In this case, the cooling step, the watering step, and the post-processing step may be performed sequentially or simultaneously.

Water or saline solution may be used in the watering step, and the amount of generation of a slurry, etc. may be controlled therethrough. The amount of water used may be appropriately adjusted in consideration of the moisture content of the intended final product, and preferably, 0.1 to 10 wt %, 0.5 to 8 wt %, or 1 to 5 wt % relative to the absorbent polymer may be used but is not limited thereto.

In addition, a maturing step may be further performed after the watering step.

In the watering step, when using saline solution, the solution absorption rate is relatively low due to the conductivity of the saline solution, so that the saline solution is evenly distributed in the maturation step, enabling even absorption of the absorbent polymer. The maturation step may be applied to a commonly used method without any special limitation, and for example, it may be performed at 100° C. or less, 80° C. or less, preferably 50° C. or less for 10 minutes to 1 hour using a rotary stirring device.

The additives added in the post-processing step may be a surfactant, an inorganic salt, a permeability enhancer, an anti-caking agent, a fluidity enhancer, and an antioxidant, but the present disclosure is not limited thereto.

By selectively performing the cooling step, watering step, and post-processing step, the moisture content of the final super absorbent polymer may be improved by controlling the occurrence of slurry, etc., and a super absorbent polymer product with better quality may be prepared.

The description of the method for preparing the super absorbent polymer of the present disclosure may be applied to the super absorbent polymer of the present disclosure described above.

Hereinafter, the operation and effect of the disclosure will be described in more detail through particular examples of the disclosure. However, the examples are merely presented as examples of the disclosure, and the scope of the disclosure is not determined by them.

### EXAMPLES

### 1) Example 1

### (Step 1: Polymerization Step—Hydrogel Polymer Preparation Step)

In a 2 L glass vessel equipped with a stirrer and a thermometer, 1,000 g of acrylic acid, 2.5 g of pentaerythritol triallyl ether (PETTAE) as an internal crosslinking agent, and 2,260 g of water were mixed while stirring. In this case, the reaction temperature was maintained at 5° C. 1,000 cc/min of nitrogen was introduced into the glass vessel containing the mixture for 1 hour to replace the inside of the glass vessel with nitrogen conditions. Thereafter, 13.0 g of a 0.3% hydrogen peroxide aqueous solution, 15.0 g of a 1% ascorbic acid aqueous solution, and 30.0 g of a 2% 2,2′-azobis amidinopropane dihydrochloride aqueous solution were introduced as polymerization initiators. At the same time, 15.0 g of a 0.01% iron sulfate aqueous solution as a reducing agent was added and mixed to initiate polymerization. In the mixture, a polymerization reaction was initiated, and after the temperature of the polymer reached 85° C., the polymerization was performed in an oven at 90±2° C. for about 6 hours to produce a hydrogel polymer.

### (Steps 2 and 3: Micronization and Neutralization Steps)

1,000 g of the hydrogel polymer obtained in Step 1 and 0.1 g of glycerol monolaurate (GML) were dissolved in water at 60° C. or higher and introduced into a cylindrical pulverizer in the form of an aqueous solution. Thereafter, the aqueous solution was pushed out at a rotation speed of 1,700 rpm through a porous plate having multiple 10 mm holes formed therein using a high-speed rotary shredder (F-150/Karl Schnell) mounted inside the cylindrical pulverizer. Subsequently, the aqueous solution was further pushed out at a rotation speed of 1,800 rpm through a porous plate having multiple 10 mm holes formed therein to obtain a pulverized gel-type hydrogel polymer. Thereafter, the pulverized gel-type hydrogel polymer was pushed out three times through a porous plate having multiple 6 mm holes at a rotation speed of 250 rpm using a screw-type extruder mounted inside a cylindrical pulverizer to obtain hydrous super absorbent polymer particles.

In this case, 450 g of a 32% NaOH aqueous solution was added for the first pass through the porous plate, and 42.8 g of a 0.5% Na₂S₂O₈ aqueous solution (SPS aqueous solution) was added for the second pass and pushed out through the porous plate. For the third pass, no additives were added, and the polymer was passed through the porous plate.

### (Step 4: Drying Step)

The hydrous super absorbent polymer particles obtained as a result of the pulverization were placed on a porous plate capable of vertically transferring airflow and dried at 120° C. for 40 minutes using an air-flow oven.

The water content of the dried super absorbent polymer was about 10%, and hot air of 200° C. and 100° C. was sequentially flowed from the top to the bottom for 5 minutes and 10 minutes, respectively, and then hot air of 100° C. was flowed from the bottom to the top for 15 minutes to uniformly dry the hydrous super absorbent polymer particles and obtain a dried product.

### (Step 5: Pulverization and Classification Steps)

The dried product was pulverized with a pulverizer (GRAN-U-LIZER™, MPE) and then classified with a standard mesh sieve of ASTM standards to obtain a base resin powder having a size of 150 to 850 μm.

### (Step 6: Surface Crosslinking Step)

Next, as described in Table 1 below, for 100 g of the base resin powder, a surface crosslinking agent aqueous solution containing 4 g of water, 6 g of methanol, 0.08 g of ethylene glycol diglycidyl ether (EJ-1030S), 0.1 g of propylene glycol, 0.2 g of aluminum sulfate, and 0.1 g of silica particles (Aerosil 200) was added and mixed. In this case, the surface crosslinking agent aqueous solution was mixed so as to be evenly distributed on the super absorbent polymer powder.

Subsequently, the base resin powder mixed with the surface crosslinking solution was placed in a surface crosslinking reactor and a surface crosslinking reaction was performed to obtain a surface crosslinked super absorbent polymer.

Specifically, in the surface crosslinking reactor, the base resin powder underwent a surface crosslinking reaction at 140° C. for 50 minutes.

After the surface crosslinking step, the surface-crosslinked super absorbent polymer was classified through a standard mesh sieve according to ASTM standards to produce a super absorbent polymer having a particle size of 150 μm to 850 μm.

### 2) Example 2

### (Step 1: Polymerization Step—Hydrogel Polymer Preparation Step)

A hydrogel polymer was prepared in the same manner as in Example 1.

### (Steps 2 and 3: Micronization and Neutralization Steps)

1,000 g of the hydrogel polymer obtained in Step 1 and 0.1 g of glycerol monolaurate (GML) were dissolved in water at 60° C. or higher and placed in a cylindrical pulverizer in the form of an aqueous solution. Then, using a high-speed rotary shredder (F-150/Karl Schnell) installed inside the cylindrical pulverizer, the aqueous solution was pushed out at a rotation speed of 1,500 rpm through a porous plate having multiple 8 mm holes formed therein. Subsequently, the aqueous solution was further pushed out at a rotation speed of 2,600 rpm through a porous plate having multiple 10 mm holes formed therein to obtain a hydrogel polymer in the form of a pulverized gel. Thereafter, the pulverized gel-shaped hydrogel polymer was extruded three times through a porous plate having multiple 6 mm holes at a rotation speed of 250 rpm using a screw-type extruder mounted inside a cylindrical pulverizer to obtain hydrous super absorbent polymer particles.

In this case, 385 g of a 32% NaOH aqueous solution was added for the first pass through the porous plate, and 42.8 g of a 0.5% Na₂S₂O₈ aqueous solution (SPS aqueous solution) was added for the second pass and extruded through the porous plate. For the third pass, no additives were added, and the polymer was passed through the porous plate.

### (Step 4: Drying Step)

The hydrous super absorbent polymer particles were uniformly dried in the same manner as in Example 1 to obtain a dried product.

### (Step 5: Pulverization and Classification Steps)

The dried product was pulverized with a pulverizer (GRAN-U-LIZER™, MPE) and then classified with a standard mesh sieve of ASTM standards to obtain a base resin powder having a size of 150 to 850 μm.

### (Step 6: Surface Crosslinking Step)

The surface crosslinking step was performed in the same manner as in Example 1, except that the components and contents of the surface crosslinking agent aqueous solution were prepared as described in Table 1 below, to prepare a super absorbent polymer of Example 2.

### 3) Example 3

### (Step 1: Polymerization Step—Hydrogel Polymer Preparation Step)

A hydrogel polymer was prepared in the same manner as in Example 1.

### (Steps 2 and 3: Micronization and Neutralization Steps)

Hydrous super absorbent polymer particles were obtained in the same manner as in Example 1 except that 420 g of a 32% NaOH aqueous solution was added instead of 450 g of a 32% NaOH aqueous solution per pass through the porous plate in Example 1.

### (Step 4: Drying Step)

Hydrous super absorbent polymer particles were uniformly dried in the same manner as in Example 1 to obtain a dried product.

### (Step 5: Pulverization and Classification Steps)

The dried product was pulverized with a pulverizer (GRAN-U-LIZER™, MPE) and then classified with a standard mesh sieve of ASTM standards to obtain a base resin powder having a size of 150 to 850 μm.

### (Step 6: Surface Crosslinking Step)

A super absorbent polymer of Example 3 was prepared by performing the surface crosslinking step in the same manner as in Example 1 except for changing the components and contents of the surface crosslinking agent aqueous solution as in Table 1 below.

### 4) Comparative Example 1

### (Step 1: Polymerization Step—Hydrogel Polymer Preparation Step)

A hydrogel polymer was prepared in the same manner as in Example 1.

### (Steps 2 and 3: Micronization and Neutralization Steps)

1,000 g of the hydrogel polymer obtained in Step 1 and 0.1 g of glycerol monolaurate (GML) were dissolved in water at 60° C. or higher and placed in a cylindrical pulverizer in the form of an aqueous solution. Thereafter, the mixture was pushed out through a porous plate having multiple 10 mm holes at a rotation speed of 1,800 rpm using a high-speed rotary shredder (F-150/Karl Schnell) mounted inside the cylindrical pulverizer. Then, the pulverized gel-shaped hydrogel polymer was additionally pushed out through a porous plate having multiple 10 mm holes at a rotation speed of 2,200 rpm to obtain a pulverized gel-shaped hydrogel polymer. After that, the pulverized gel-shaped hydrogel polymer was pushed out through a porous plate having multiple 6 mm holes at a rotation speed of 250 rpm three times using a screw-type extruder mounted inside a cylindrical pulverizer to obtain hydrous super absorbent polymer particles.

In this case, 330 g of a 32% NaOH aqueous solution was added for the first pass through the porous plate, and 42.8 g of a 0.5% Na₂S₂O₈ aqueous solution (SPS aqueous solution) was added for the second pass and pushed out through the porous plate. For the third pass, no additives were added, and the polymer was passed through the porous plate.

### (Step 4: Drying Step)

The hydrous super absorbent polymer particles were uniformly dried in the same manner as in Example 1 to obtain a dried product.

### (Step 5: Pulverization and Classification Steps)

The dried material was pulverized with a pulverizer (GRAN-U-LIZER™, MPE) and then classified with a standard mesh sieve of ASTM standards to obtain a base resin powder having a size of 150 to 850 μm.

### (Step 6: Surface Crosslinking Step)

The surface crosslinking step was performed in the same manner as in Example 1, except that the components and contents of the surface crosslinking agent aqueous solution were prepared as described in Table 1 below, to prepare a super absorbent polymer of Comparative Example 1.

### 5) Comparative Example 2

### (Step 1: Polymerization Step—Hydrogel Polymer Preparation Step)

A hydrogel polymer was prepared in the same manner as in Example 1.

### (Steps 2 and 3: Micronization and Neutralization Steps)

A hydrous super absorbent polymer particles were obtained in the same manner as in Example 1 except that 310 g of a 32% NaOH aqueous solution was added instead of 450 g of a 32% NaOH aqueous solution per pass through the porous plate in Example 1.

### (Step 4: Drying Step)

The hydrous super absorbent polymer particles were uniformly dried in the same manner as in Example 1 to obtain a dried product.

### (Step 5: Pulverization and Classification Steps)

The dried product was pulverized with a pulverizer (GRAN-U-LIZER™, MPE) and then classified with a standard mesh sieve of ASTM standards to obtain a base resin powder having a size of 150 to 850 μm.

### (Step 6: Surface Crosslinking Step)

A super absorbent polymer of Comparative Example 2 was prepared by performing the surface crosslinking step in the same manner as in Example 1 except for changing the components and contents of the surface crosslinking agent aqueous solution as in Table 1 below.

### 6) Comparative Example 3

### (Step 1: Polymerization Step—Hydrogel Polymer Preparation Step)

A hydrogel polymer was prepared in the same manner as in Example 1.

### (Steps 2 and 3: Micronization and Neutralization Steps)

1,000 g of the hydrogel polymer obtained in Step 1 and 0.1 g of glycerol monolaurate (GML) were dissolved in water at 60° C. or higher and placed in a cylindrical pulverizer in the form of an aqueous solution. Thereafter, the mixture was pushed out through a porous plate having multiple 10 mm holes at a rotation speed of 1,500 rpm using a high-speed rotary shredder (F-150/Karl Schnell) installed inside the cylindrical pulverizer. Then, the pulverized gel-shaped hydrogel polymer was additionally pushed out through a porous plate having multiple 8 mm holes at a rotation speed of 2,700 rpm to obtain a pulverized gel-shaped hydrogel polymer. After that, the pulverized gel-shaped hydrogel polymer was pushed out through a porous plate having multiple 6 mm holes at a rotation speed of 250 rpm three times using a screw-type extruder mounted inside a cylindrical pulverizer to obtain hydrous super absorbent polymer particles.

In this case, 325 g of a 32% NaOH aqueous solution was added for the first pass through the porous plate, and 42.8 g of a 0.5% Na₂S₂O₈ aqueous solution (SPS aqueous solution) was added for the second pass and pushed out through the porous plate. For the third pass, no additives were added, and the polymer was passed through the porous plate.

### (Step 4: Drying Step)

The hydrous super absorbent polymer particles were uniformly dried in the same manner as in Example 1 to obtain a dried product.

### (Step 5: Pulverization and Classification Steps)

The dried material was pulverized with a pulverizer (GRAN-U-LIZER™, MPE) and then classified with a standard mesh sieve of ASTM standards to obtain a base resin powder having a size of 150 to 850 μm.

### (Step 6: Surface Crosslinking Step)

A super absorbent polymer of Comparative Example 3 was prepared by performing the surface crosslinking step in the same manner as in Example 1, except for changing the components and contents of the surface crosslinking agent aqueous solution as in Table 1 below.

TABLE 1

| | A | B | C | D | E | F | G |
|---|---|---|---|---|---|---|---|
| Example 1 | 4 | 6 | 0.08 | 0.1 | 0.2 | — | 0.1 |
| Example 2 | 5 | 6 | 0.08 | 0.1 | 0.2 | 0.03 | 0.25 |
| Example 3 | 4 | 6 | 0.08 | 0.1 | — | 0.1 | 0.15 |
| Comparative | 6 | 6 | 0.1 | 0.1 | — | — | 0.25 |
| Example 1 | | | | | | | |
| Comparative | 5 | 6 | 0.1 | 0.1 | 0.4 | 0.03 | 0.1 |
| Example 2 | | | | | | | |
| Comparative | 5 | 6 | 0.1 | 0.1 | 0.1 | 0.2 | 0.05 |
| Example 3 | | | | | | | |

The materials of A to G in Table 1 are as follows, and in Table 1, [symbol] means a component not included in the surface crosslinking agent aqueous solution, and the unit of each number is g. That is, Table 1 means the amount of material used per 100 g of the base resin powder.
A: Water
B: Methanol
C: Ethylene glycol diglycidyl ether
D: Propylene glycol
E: Aluminum sulfate
F: Sucrose stearates
G: Silica

### <Experimental Example 1>—Deodorization Rate Evaluation

The deodorization efficacy of the super absorbent polymer was evaluated for four types of odor standard substances.

Dimethyl disulfide (DMDS), dimethyl trisulfide (DMTS), diacetyl, and isovaleraldehyde were used as odor standard substances.

Dimethyl disulfide (DMDS, CAS No.: 624-92-0), dimethyl trisulfide (DMTS, CAS No.: 3658-80-8), diacetyl (CAS No.: 431-03-8), and isovaleraldehyde (CAS 58-41 2022-07-26 No. 590-86-3) were sufficiently dissolved in a physiological saline solution to have a concentration within a range of 30 g/mL to 250 g/mL, respectively, to prepare a mixed solution.

Then, the mixed solution and a 0.9 wt % NaCl aqueous solution were mixed at a volume ratio of 1:1000 (mixed solution: NaCl aqueous solution) to prepare an odor standard substance solution. As the physiological saline solution, a 0.9 wt % NaCl solution was used.

Next, 80 mg of the super absorbent polymer of Example 1 was placed in a 20 mL vial, and 2 mL of the odor standard substance solution was injected.

The vial was sealed and maintained at a temperature of 35° C. for about 2 hours. The injection of the odor standard substance solution and the maintenance at 35° C. for 2 hours were performed using a PAL RTC automatic injection system from CTC.

The odor standard substance was adsorbed for about 15 minutes at a temperature in a range of 30° C. to 40° C. using a Solid Phase Micro Extraction (SPME) Arrow (Carbon WR/PDMS Fiber) equipped on the PAL RTC automatic injection system, and the peak area of the odor standard substance after the adsorption was confirmed using a gas chromatography-mass spectrometry (GC-MS). As the GC-MS system, Agilent's 8890 GC/5977B MSD was used. The SPME Arrow mounted on the PAL RTC was injected into a Split/Splitless inlet, and DB-624 Ultra Inert (UI) was used as a column.

During the measurement, He gas was used as the mobile phase, and the heater temperature of the sample inlet was set to around 250° C. during injection to desorb the sample adsorbed by Solid Phase Micro Extraction (SPME).

After that, the deodorization rate for each odor standard substance was confirmed using Equation 1 below.

$$Deodorization rate ( \% ) = ( 1 - Cs / Co ) \times 100 \qquad [ Equation 1 ]$$

In Equation 1, Cs is the peak area of an odor standard substance in a gas chromatography-mass spectrometry (GC-MS) graph for an odor standard substance solution that contacted the super absorbent polymer of Example 1 for 2 hours at 35° C., and Co is the peak area of an odor standard substance in a gas chromatography-mass spectrometry graph for an odor standard substance solution that contacted a control group for 2 hours at 35° C.

As the control group, GS4800 of LG Chem, a general-purpose super absorbent polymer, was used. The deodorization rate was obtained in the same manner for the super absorbent polymers of Examples 2 and 3 and the Comparative Examples.

TABLE 2

| | | | | Comparative | Comparative | Comparative |
|---|---|---|---|---|---|---|
| | Example | Example | Example | Example | Example | Example |
| | 1 | 2 | 3 | 1 | 2 | 3 |
| DMDS | −23 | −61 | 55 | 8 | −55 | −36 |
| DMTS | 63 | 52 | 2 | −8 | −60 | −58 |
| Diacetyl | 14 | 46 | 75 | −14 | 3 | −2 |
| Isovaleraldehyde | 19 | 61 | 83 | −30 | −22 | −45 |

### <Experimental Example 2>—Measurement of Surface Area Relative to Actual Volume of Super Absorbent Polymer

The surface area relative to the actual volume of the super absorbent polymer of Example 1 was obtained according to steps 1 to 3 below.

### Step 1) Drying and Sampling of Super Absorbent Polymer

The super absorbent polymer of Example 1 was dried at about 100° C. for about 12 hours, and the dried super absorbent polymer was sampled to a size of 1.5 cm×1.5 cm×1.5 cm (width×length×height).

### Step 2) Image Derivation

The sampled super absorbent polymer of Example 1 was analyzed using XRM (ZEISS Xradia 620 Versa) under the conditions below to derive a 3D image of the super absorbent polymer.

### <Conditions>

X-Ray Energy: 70 kV
Detector: Flat Pane
Voxel Size: 5 μm
Measurement Time: 0.05 s/frame
Total Images: 4501
   Step 3) Derivation of Surface Area to Actual Volume (S_{SAP}/V_{C})
1) The region of interest (measurement region) was set and cut out from the 3D reconstructed XRM cross-section 2D image of the super absorbent polymer of Example 1.
2) Gaussian blur was applied to the cut 2D cross-section image to remove noise. Then, the 2D cross-section image was converted into a binarized image using an Otsu's thresholding method to distinguish the background image and the super absorbent polymer particle image. This was applied to all 2D cross-section images of the measurement targets to obtain 2D cross-section images with the separated super absorbent polymer particles.
3) The multiple 2D cross-section images were stacked and 3D rendering was performed.
4) The volume (V_{C}) of the entire particles of the super absorbent polymer of Example 1 was measured from the 3D rendered volume data. In addition, considering the connectivity of the 3D rendered image, the surface area (S_{SAP}) of the entire particles of the super absorbent polymer of Example 1 excluding the surface area of the closed pore region was measured. The surface area (S_{SAP}) of the super absorbent polymer particles of Example 1 was divided by the volume (V_{C}) of the entire particles of the super absorbent polymer of Example 1 to derive the surface area relative to the actual volume of the super absorbent polymer of Example 1.

The results are shown in Table 3 below.

The surface area relative to the actual volume was also obtained for the super absorbent polymers of Examples 2 and 3 and the Comparative Examples using the same method.

### [Table 3]

### <Experimental Example 3>—Measurement of Convexity and CE Diameter

Additionally, the convexity and CE diameter of the super absorbent polymer particles prepared in the Examples and Comparative Examples were measured using the methods below and are listed in Table 3 below.

Unless otherwise indicated, all the physical property evaluations below were conducted under constant temperature and humidity (23±1° C., relative humidity 50±10%), and physiological saline solution or saline solution refers to a 0.9 wt % sodium chloride (NaCl) aqueous solution.

The samples to be measured were left under constant temperature and humidity conditions for 24 hours, and then each property was evaluated.

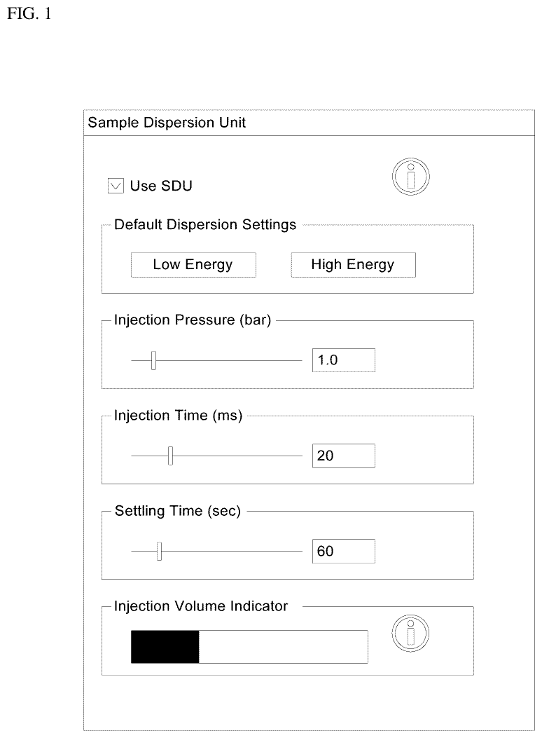

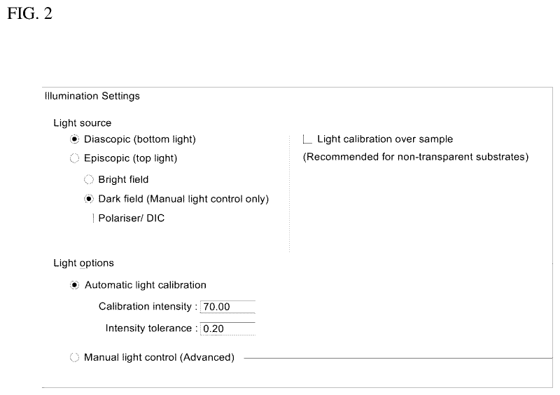

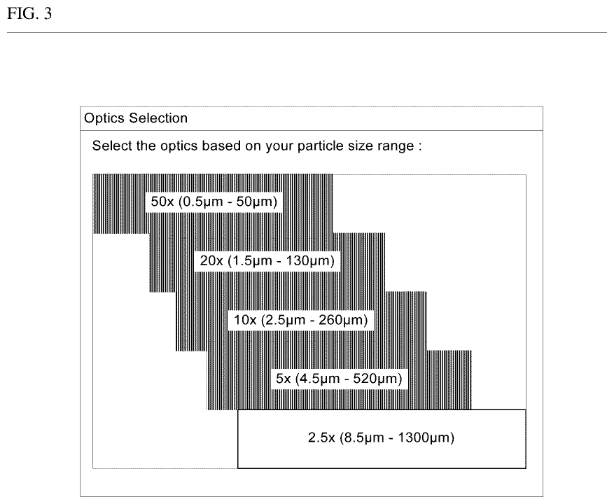

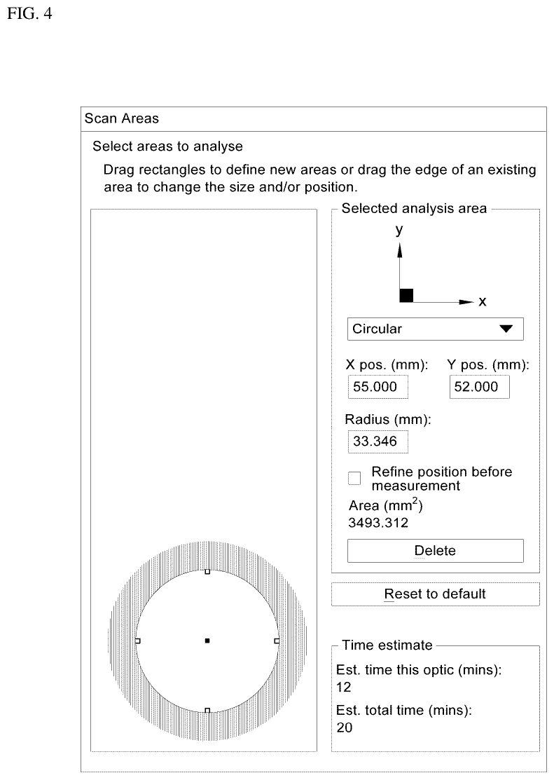

The convexity and CE diameters of the super absorbent polymers of the Examples and Comparative Examples were measured using Malvern Panalytical's Morphologi 4 using the methods below.
1) Sample preparation: 1 g of the particle sample of the super absorbent polymer to be measured was prepared. In this case, 1 g of a sample was prepared as separated individual particles with a particle size of 300 μm to 600 μm without particle damage by classifying the super absorbent polymer using a particle classifier from Retsch at 1.0 amplitude for 10 minutes. The setting value of the Sample Dispersion Unit at this time is shown in FIG. 1.
2) Image acquisition: The prepared sample was set on a stage in the equipment and then scanned at 2.5 magnification to acquire images of individual particles. In this case, the Illumination Setting value and Optics Selection Setting value are shown in FIG. 2 and FIG. 3, respectively.
3) Image processing: For the acquired image, the parameter values of the captured 2D image of the 3D image of the three-dimensional particle for each particle, the CE diameter (Circle Equivalent diameter), the shortest diameter, the longest diameter, the actual particle perimeter, and the convex hull perimeter were measured. In this case, the Scan Area setting value was as shown in FIG. 4, and the particle was measured without setting the Filtering value.

Among them, the average values of convexity and CE diameter (Circle Equivalent diameter) calculated by Equation 2 below are listed in Table 4 below.

$${M}_{c} = {L}_{s} / L \qquad [ Equation 2 ]$$

In Equation 2 above,
M_{c} is convexity,
Lₛ means the length of an elastic band when it is assumed that an imaginary elastic band that stretches around an outline surrounds an image captured as a 2D image of a 3D image of a three-dimensional particle to be measured, and
L means the actual perimeter length of the image captured as a 2D image of the 3D image of a three-dimensional particle to be measured.

TABLE 4

| | | CE diameter |
|---|---|---|
| | Convexity | average |
| | average | (μm) |
| Example 1 | 0.87 | 412 |
| Example 2 | 0.88 | 425 |
| Example 3 | 0.91 | 399 |
| Comparative | 0.92 | 321 |
| Example 1 | | |
| Comparative | 0.92 | 326 |
| Example 2 | | |
| Comparative | 0.91 | 420 |
| Example 3 | | |

### <Experimental Example 4>—Physical Property Evaluation

The physical properties of the super absorbent polymers prepared in the Examples and Comparative Examples were evaluated using the methods below and are listed in Table 4 below.

Unless otherwise specified, the property evaluations below were all conducted under constant temperature and humidity (23±1° C., relative humidity 50±10%), and physiological saline solution or saline solution refers to a 0.9 wt % sodium chloride (NaCl) solution.

The samples to be measured were left under constant temperature and humidity conditions for 24 hours, and each property was evaluated.

(1) Centrifuge Retention Capacity (CRC, g/g)

The water retention capacity of the super absorbent polymers of the Examples and Comparative Examples by the absorption rate under no-load was measured according to the European Disposables and Nonwovens Association (EDANA) standard EDANA WSP 241.3.

As described in EDANA WSP 241.0, the measurement was performed at a temperature of 23±2° C. and a relative humidity of 45±15%.

Specifically, each super absorbent polymer W₀ (g) (about 0.2 g) obtained through each of the Examples and Comparative Examples was uniformly placed in a nonwoven bag, sealed, and then immersed in a physiological saline solution (0.9 wt %) at room temperature. After 30 minutes, water was removed from the bag for 3 minutes using a centrifuge under the conditions of 250 G, and the mass W₂ (g) of the bag was measured. In addition, the same operation was performed without using the resin, and the mass W₁ (g) at that time was measured.

Using each obtained mass, CRC (g/g) was calculated according to Mathematical Equation 1 below.

$$CRC ( g / g ) = \{ [ {W}_{2} ( g ) - {W}_{1} ( g ) ] / {W}_{0} ( g ) \} - 1 \qquad [ Mathematical Equation 1 ]$$

The measurement was repeated 5 times, and the average value and standard deviation were obtained.

### (2) Absorbency Under Pressure (AUP: G/g)

The absorbency under pressure of 2.07 kPa (0.3 psi) of the super absorbent polymers of the Examples and Comparative Examples was measured according to EDANA method WSP 242.3.

The measurement was performed at a temperature of 23±2° C. and a relative humidity of 45±15% as described in EDANA WSP 242.0.

Specifically, a 400 mesh stainless steel wire mesh was installed on the bottom of a plastic cylinder with an inner diameter of 25 mm. Under the conditions of room temperature and 50% humidity, a super absorbent polymer W₃ (g) (0.9 g) was evenly sprayed on the wire mesh, and a piston capable of uniformly applying a load of 2.07 kPa (0.3 psi) with an outer diameter slightly smaller than 25 mm was installed thereon without a gap between the inner wall of the cylinder, and without obstruction of up-and-down movement. In this case, the weight W₄ (g) of the device was measured.

A glass filter with a diameter of 90 mm and a thickness of 5 mm was placed on the inside of a petri dish with a diameter of 150 mm, and a physiological saline solution composed of 0.9 wt % sodium chloride was placed so as to be at the same level as the upper surface of the glass filter. A sheet of filter paper with a diameter of 90 mm was placed thereon. The measuring device was placed on the filter paper, and the liquid was absorbed under the load for 1 hour. After 1 hour, the measuring device was lifted, and a weight Wₛ(g) was measured.

Using each mass obtained, the absorbency under pressure (g/g) was calculated according to Mathematical Equation 2 below.

$$AUP ( g / g ) = [ {W}_{5} ( g ) - {W}_{4} ( g ) ] / {W}_{3} ( g ) \qquad [ Mathematical Equation 2 ]$$

The measurement was repeated 5 times, and the average value and standard deviation were obtained.

### (3) Vortex Time

The vortex time of the super absorbent polymers of the Examples and Comparative Examples was measured using a method below.
1) First, 50 mL of 0.9% saline solution was added to a 100 mL beaker with a flat bottom using a 100 mL mass cylinder.
2) Next, the beaker was placed in the center of the magnetic stirrer, and a circular magnetic bar (diameter 30 mm) was placed inside the beaker.
3) Afterwards, the stirrer was operated so that the magnetic bar was stirred at 600 rpm, and the lowest part of the vortex created by the stirring was made to touch the top of the magnetic bar.
4) After confirming that the temperature of the saline solution in the beaker was 24.0° C., 2±0.01 g of the super absorbent polymer sample was added while simultaneously operating a stopwatch, and the time until the vortex disappeared and the liquid surface became completely horizontal was measured in seconds, which was designated as the vortex time.
   (4) 1-Minute Absorption Capacity (WFA₁₁₀) in Water with Electrical Conductivity Value of 110 μS/Cm

For the super absorbent polymers of the Examples and Comparative Examples, the 1-minute absorption capacity (WFA₁₁₀) in water with an electrical conductivity value of 110 μS/cm at 24° C. was measured using a method below. The specific measurement process was as follows.

1.0 g (W₆) of a super absorbent polymer of each of the Examples and Comparative Examples was placed in a nonwoven bag (18 cm×28 cm) and immersed in 1000 mL of water having an electrical conductivity of 110 μS/cm at 24° C. for 1 minute. After 1 minute, the bag was taken out of the water having an electrical conductivity of 110 μS/cm, hung, and left for 1 minute. Thereafter, the mass (W₈) of the bag was measured. In addition, the same operation was performed without using the super absorbent polymer, and the mass at that time (W₇) was measured. Using each mass thus obtained, the 1-minute absorption capacity (g/g) in water having an electrical conductivity of 110 μS/cm was calculated according to Mathematical Equation 3 below.

$$[ Mathematical Equation 3 ]$$

$${WFA}_{110} ( g / g ) = \{ [ {W}_{8} ( g ) - {W}_{7} ( g ) - {W}_{6} ( g ) ] / {W}_{6} ( g ) \}$$

TABLE 5

| | CRC (g/g) | AUP (g/g) | Vortex time (sec) | WFA₁₁₀ (g/g) |
|---|---|---|---|---|
| Example 1 | 38.7 | 32.2 | 17 | 190 |
| Example 2 | 31.3 | 29.1 | 23 | 143 |
| Example 3 | 35.2 | 33.1 | 35 | 185 |
| Comparative | 40.5 | 22.1 | 43 | 111 |
| Example 1 | | | | |
| Comparative | 39.1 | 26.0 | 40 | 102 |
| Example 2 | | | | |
| Comparative | 38.1 | 27.6 | 42 | 120 |
| Example 3 | | | | |

As confirmed from Tables 2 to 5 above, the super absorbent polymer according to Examples of the present disclosure had a deodorizing effect for dimethyl disulfide or dimethyl trisulfide, and at the same time had excellent absorption performance such as water retention capacity, absorbency under pressure, and absorption rate at a certain level or higher in a surface area relative to an actual volume.

The super absorbent polymer of the present disclosure not only had excellent absorption performance with a surface area relative to an actual volume of a certain level or higher but also had deodorizing effects against dimethyl disulfide or dimethyl trisulfide.

Although the super absorbent polymer has been described with reference to the specific embodiments, it is not limited thereto. Therefore, it will be readily understood by those skilled in the art that various modifications and changes can be made thereto without departing from the spirit and scope of the present disclosure defined by the appended claims.

What is claimed is:

1. A super absorbent polymer of a polyacrylic acid (salt)-based super absorbent polymer, comprising:
a surface area of 45 mm⁻¹ or more relative to an actual volume, and
a deodorization rate of 40% or more according to the following Equation 1 for dimethyl disulfide (DMDS) or dimethyl trisulfide (DMTS):
$$Deodorization rate ( \% ) = ( 1 - Cs / Co ) \times 100 \qquad [ Equation 1 ]$$
wherein,
Cs is a peak area of an odor standard substance in a gas chromatography-mass spectrometry (GC-MS) graph for an odor standard substance solution that contacted the super absorbent polymer at 35° C. for 2 hours, and
Co is a peak area of an odor standard substance in a gas chromatography-mass spectrometry graph for an odor standard substance solution that contacted a control group at 35° C. for 2 hours.

2. The super absorbent polymer of claim 1, wherein the super absorbent polymer has a deodorization rate of 10% or more for diacetyl.

3. The super absorbent polymer of claim 1, wherein the super absorbent polymer has a deodorization rate of 10% or more for isovaleraldehyde.

4. The super absorbent polymer of claim 1, wherein the surface area relative to the actual volume is 65 mm⁻¹ or less.

5. The super absorbent polymer of claim 1, wherein the super absorbent polymer is a super absorbent polymer having an average value of convexity calculated by the following Equation 2 for all particles of 0.94 or less:
$${M}_{c} = {L}_{s} / L \qquad [ Equation 2 ]$$
wherein,
M_{c} is convexity,
Lₛ means a length of an elastic band when it is assumed that an imaginary elastic band that stretches around an outline surrounds an image captured as a 2D image of a 3D image of a three-dimensional particle to be measured, and
L means an actual perimeter length of the image captured as a 2D image of the 3D image of a three-dimensional particle to be measured.

6. The super absorbent polymer of claim 1, wherein the super absorbent polymer has an average CE diameter (Circle Equivalent diameter) of from 220 μm to 450 μm.

7. The super absorbent polymer of claim 1, wherein the super absorbent polymer has a water retention capacity (CRC) of 28 g/g or more as measured according to a method of EDANA method WSP 241.3.

8. The super absorbent polymer of claim 1, wherein the super absorbent polymer has an absorbency under pressure (AUP) of 25 g/g or more as measured under 2.07 kPa (0.3 psi) according to EDANA method WSP 242.3.

9. The super absorbent polymer of claim 1, wherein when the super absorbent polymer is swollen in water having an electrical conductivity of 100 to 130 μS/cm for 1 minute, a maximum capacity of water that the super absorbent polymer holds (Free Swell Capacity) is 130 g/g or more.
